(19) United States
(12) Patent Application Publication
(10) Pub. No.: US 2025/0297146 A1
(43) Pub. Date: Sep. 25, 2025

(54) WET AND DRY ADHESIVE SHAPE MEMORY ELASTOMERS

(71) Applicant: The Curators of the University of Missouri, Columbia, MO (US)

(72) Inventors: Jian Lin, Columbia, MO (US); Yuchao Wu, Columbia, MO (US); Sonia Norouzi Esfahany, Columbia, MO (US); Alireza Mahjoubnia, Columbia, MO (US)

(21) Appl. No.: 19/082,985

(22) Filed: Mar. 18, 2025

Related U.S. Application Data
(60) Provisional application No. 63/567,535, filed on Mar. 20, 2024.

(51) Int. Cl. C09J 139/06; C09J 9/00

(52) U.S. Cl. CPC C09J 139/06; C09J 9/00

(57) ABSTRACT

Described herein in various embodiments is an adhesive shape memory elastomer (SME) that can adhere to a substrate surface. The SME has an original shape that is set during synthesis of the adhesive SME. The adhesive SME comprises a copolymer network that includes a first monomer residue which is a hydrophilic biocompatible residue with at least one hydrogen bond acceptor, a second monomer residue which has a hydrophobic alkyl side chain, and a third monomer residue that includes at least one hydrogen bond donor. The first, second, and third monomer residue are covalently bonded to one another. The adhesive SME can adhere to the substrate surface via noncovalent interactions between the copolymer network and the substrate surface.

### CROSS-REFERENCE TO RELATED APPLICATIONS

This application claims priority to U.S. Provisional Application No. 63/567,535 filed on Mar. 20, 2024, the content of which (text, drawings, and claims) is incorporated herein by reference.

### GOVERNMENT RIGHTS

This invention was made with government support under EY034254 awarded by the National Institutes of Health, and 1825352 awarded by the National Science Foundation. The government has certain rights in the invention.

### TECHNICAL FIELD

The present teachings relate to four-dimensional printing, shape memory elastomers, adhesives, and reversible wet adhesives.

### BACKGROUND

Traditional approaches to soft electronics and adhesives have relied on materials such as epoxy, silicone, polydimethylsiloxane (PDMS), polyurethane, and various elastomers. While these materials offer high stretchability, they often struggle with staying robustly adhered to a given substrate if the substrate is too rough and/or if the adhesive is exposed to water. The presence of water at material interfaces can significantly reduce adhesion strength by weakening key intermolecular forces such as van der Waals and hydrogen bonding, particularly on rough surfaces where water can become trapped and create interfacial defects.

Insufficient mechanical stability under deformation, limited stretchability, poor wet adhesion, and biocompatibility concerns are common to modern adhesive systems. Additionally, many current systems are petroleum-based, raising sustainability concerns. Shape memory elastomers (SMEs) have emerged as promising materials for advanced applications such as robust adhesives, particularly in biomedical contexts. SMEs are stimulus-responsive elastomers that can transition between glassy and rubbery states, accompanied by significant physical and chemical changes that enable them to conform to complex surface shapes, materials, and roughness levels. However, uniting and controlling the properties of SMEs for particular applications has proven to be a considerable challenge. A critical need exists for materials such as SMEs that can simultaneously achieve high stretchability, robust wet adhesion, biocompatibility, and appropriate transition temperatures near body temperature. Such materials would be particularly valuable for next-generation soft electronics and biomedical devices that require intimate, stable contact with dynamic biological tissue surfaces under physiological conditions.

### BRIEF SUMMARY

Described herein in various embodiments is an adhesive shape memory elastomer (SME) that can adhere to a substrate surface. The SME has an original shape that is set during synthesis of the adhesive SME. The adhesive SME comprises a copolymer network that includes a first monomer residue which is a hydrophilic biocompatible residue with at least one hydrogen bond acceptor, a second monomer residue which has a hydrophobic alkyl side chain, and a third monomer residue that includes at least one hydrogen bond donor. The first, second, and third monomer residue are covalently bonded to one another. The adhesive SME can adhere to the substrate surface via noncovalent interactions between the copolymer network and the substrate surface.

In various exemplary embodiments, the adhesive SME undergoes a transition from a glassy state to a rubbery state as it is heated past a glass transition temperature T_{g}. The adhesive SME in the rubbery state can be deformed from the original shape to a programmed shape. When the adhesive SME in the rubbery state is applied to the substrate surface, the programmed shape of the adhesive SME conforms to the the substrate surface. When subsequently cooled, the adhesive SME assumes the glassy state and physically adheres to the substrate surface.

In various exemplary embodiments, the first monomer residue is a residue of N-vinylpyrrolidone (NVP), the second monomer residue is a residue of dodecyl acrylate (DA), and the third monomer residue is a residue of 2-hydroxy-3-phenoxypropyl acrylate (HA), and the copolymer network is a NVP-DA-HA copolymer network.

In various exemplary embodiments, T_{g} is between 10° C. and 60° C. In various exemplary embodiments, the NVP-DA-HA copolymer network comprises NVP, DA, and HA in a NVP:DA:HA weight ratio of 1:3.2:1. In various exemplary embodiments, the adhesive SME exhibits an adhesion strength of greater than 200 kPa when adhered to the substrate surface.

Also described herein in various exemplary embodiments is a biocompatible adhesive shape memory elastomer (SME) that can adhere to a substrate surface. The biocompatible adhesive SME has an original shape that is set during a synthesis of the biocompatible adhesive SME. The biocompatible adhesive SME includes a copolymer network that includes a first monomer residue, a second monomer residue, and an oligomer residue. The first monomer residue is a hydrophilic biocompatible monomer residue with at least one first hydrogen bond acceptor. The second monomer residue is a monomer residue with a hydrophobic alkyl side chain. The oligomer residue includes at least one second hydrogen bond acceptor and an alkyl chain. The first monomer residue, the second monomer residue, and the oligomer residue are covalently bonded to one another, and the biocompatible adhesive SME can adhere to the substrate surface via noncovalent interactions between the copolymer network and the substrate surface.

In various exemplary embodiments, the biocompatible adhesive SME undergoes a transition from a glassy state to a rubbery state as it is heated past a glass transition temperature T_{g}. The biocompatible adhesive SME in the rubbery state can be applied to the substrate surface, whereby the biocompatible adhesive SME is deformed to a programmed shape that conforms to the substrate surface, and the biocompatible adhesive SME can subsequently be cooled to the glassy state to adhere to the substrate surface. In various exemplary embodiments, the biocompatible adhesive SME can feature a second transition temperature T₂.

In various exemplary embodiments, the first monomer residue is a residue of N-vinylpyrrolidone (NVP), the second monomer residue is a residue of dodecyl acrylate (DA), and the oligomer residue is a residue of poly(ethylene glycol-co-dodecanedioic acid) diacrylate (AcP), and the copolymer network is a NVP-DA-AcP copolymer network. In various exemplary embodiments, the NVP-DA-AcP copolymer network comprises NVP, DA, and AcP in a NVP:DA weight ratio of 1:1 and an AcP percentage of 2.5% by weight. In various exemplary embodiments, the biocompatible SME undergoes a physical transition at a glass transition temperature T_{g} in the range of 10° C.-60° C. In various exemplary embodiments, the biocompatible SME undergoes a physical transition at a glass transition temperature T_{g} in the range of 38° C.-42° C. In various exemplary embodiments, the biocompatible adhesive SME exhibits an adhesion strength greater than 250 kPa when adhered to aluminum.

Also described herein in various exemplary embodiments is a shape memory elastomer (SME). The SME includes a copolymer network and the copolymer network includes a first monomer residue, a second monomer residue, and a crosslinker. The first monomer residue is a hydrophilic biocompatible monomer residue with at least one hydrogen bond acceptor. The second monomer residue is a monomer residue with a hydrophobic alkyl side chain. The crosslinker is one of either a third monomer residue or an oligomer residue. The third monomer residue includes at least one hydrogen bond donor. The oligomer residue includes at least one second hydrogen bond acceptor and an alkyl chain. The first monomer residue, the second monomer residue, and the crosslinker are covalently bonded to one another.

In various exemplary embodiments, the first monomer residue is a residue of N-vinylpyrrolidone (NVP), the second monomer residue is a residue of dodecyl acrylate (DA), the third monomer residue is a residue of 2-hydroxy-3-phenoxypropyl acrylate (HA) and the oligomer residue is a residue of poly(ethylene glycol-co-dodecanedioic acid) diacrylate (AcP). In various exemplary embodiments, the SME undergoes a physical transition at a glass transition temperature T_{g} in the range of 10° C.-60° C. In various exemplary embodiments, the SME undergoes a physical transition at a glass transition temperature T_{g} in the range of 38° C.-42° C.

### BRIEF DESCRIPTION OF THE FIGURES

FIG. 1A exemplarily depicts a diagram of an adhesive SME in accordance with various embodiments of the present disclosure.

FIG. 1B exemplarily depicts a diagrammatic bonding structure of an exemplary adhesive SME in accordance with various embodiments of the present disclosure.

FIG. 1C exemplarily depicts a diagrammatic depiction of hydrogen bonds formed in an exemplary adhesive SME in accordance with various embodiments of the present disclosure.

FIG. 1D exemplarily depicts a diagrammatic model for adhesion of an exemplary adhesive SME to a substrate in accordance with various embodiments of the present disclosure.

FIGS. 2A-2C exemplarily depict an exemplary adhesive SME being applied to a roughened surface in accordance with various embodiments of the present disclosure. FIG. 2A shows the exemplary adhesive SME in its original shape, FIG. 2B shows programming of the exemplary adhesive SME at an elevated temperature, and FIG. 2C shows the programmed exemplary adhesive SME mechanically adhered to the roughened surface.

FIG. 3A exemplarily depicts application of an exemplary adhesive SME to a substrate in a wet environment in accordance with various embodiments of the present disclosure.

FIG. 3B exemplarily depicts application of an exemplary adhesive SME to a humans skin substrate in an underwater environment to protect an exemplary biosensor in accordance with various embodiments of the present disclosure.

FIG. 4A exemplarily depicts a biocompatible adhesive SME which comprises the AcP-DA-NPV network in accordance with various embodiments of the present disclosure.

FIG. 4B exemplarily depicts an exemplary schematic of the AcP-DA-NVP network in accordance with various embodiments of the present disclosure.

FIGS. 5A-5C exemplarily depict viscosity shear rate curves of inks made from varying ratios of DA, HA, and NVP, respectively, in accordance with various embodiments of the present disclosure.

FIGS. 6A-6C exemplarily depict stress-strain curves of exemplary adhesive SMEs with different ratios of DA, HA, and NVP, respectively, in accordance with various embodiments of the present disclosure.

FIGS. 7A-7C exemplarily depict curves showing the effect of monomer residue weight ratios on strain, tensile strength, and Young's modulus, respectively, of exemplary adhesive SMEs in accordance with various embodiments of the present disclosure.

FIG. 8A exemplarily depicts cyclic tensile curves of exemplary DA-3.2 adhesive SME samples in accordance with various embodiments of the present disclosure.

FIG. 8B exemplarily depicts cyclic tensile curves of exemplary NVP-2.2 adhesive SME samples in accordance with various embodiments of the present disclosure.

FIG. 8C exemplarily depicts stress-strain curves of exemplary NVP-1.4, NVP-1.8, and NVP-2.2 adhesive SME samples above T_{g} in accordance with various embodiments of the present disclosure.

FIG. 9A exemplarily depicts shear stress-strain curves of exemplary DA-3.2 adhesive SME samples as a function of various substrates with various embodiments of the present disclosure.

FIG. 9B exemplarily depicts curves showing the adhesion strengths of exemplary DA-3.2 adhesive SME samples as a function of duration of immersion in water in accordance with various embodiments of the present disclosure.

FIG. 9C exemplarily depicts the weight change of exemplary DA-3.2, HA-2.2, and NVP-2.2 adhesive SMEs as a function of time spent immersed in water in accordance with various embodiments of the present disclosure.

FIG. 9D exemplarily depicts a cyclability test to show reversible wet adhesion of an exemplary DA-3.2 adhesive SME to polyethylene in accordance with various embodiments of the present disclosure.

FIG. 10A exemplarily depicts adhesion stress-strain curves of an exemplary NVP-2.2 adhesive SME to three brass samples with different roughness in accordance with various embodiments of the present disclosure.

FIG. 10B exemplarily depicts stress-strain curves of an exemplary HA-2.2 adhesive SME applied to polyimide and polyethylene above and below T_{g} in accordance with various embodiments of the present disclosure.

FIGS. 11A-11C exemplarily depict stress-strain curves of exemplary samples printed from inks with varying AcP ratios and 2:1 DA:NVP, 1:1 DA:NVP, 1:2 DA:NVP, respectively in accordance with various embodiments of the present disclosure.

FIG. 11D exemplarily depicts tensile strength and fracture strain of samples as a function of DA:NVP ratios of 2:1, 1:1, and 1:2 and different AcP ratios in accordance with various embodiments of the present disclosure.

FIG. 11E exemplarily depicts toughness and Young's modulus measurements of exemplary biocompatible adhesive SMEs printed from inks with 1:1 DA:NVP ratios and different AcP weight ratios in accordance with various embodiments of the present disclosure.

FIG. 11F exemplarily depicts DMA curves of exemplary biocompatible adhesive SMEs printed from inks with 1:2 DA:NVP ratios and AcP weight ratios of 2.5%, 5%, and 10% in accordance with various embodiments of the present disclosure.

FIG. 12 exemplarily depicts dynamic mechanical analysis test results for exemplary biocompatible adhesive SME samples with varying DA:NVP ratios and 10% AcP in accordance with various embodiments of the present disclosure.

FIG. 13A exemplarily depicts adhesion strength of exemplary biocompatible adhesive SMEs with a ratio of 1:1 DA:NVP and varying AcP weight percentages applied to aluminum in accordance with various embodiments of the present disclosure.

FIG. 13B exemplarily depicts adhesion strength of exemplary biocompatible adhesive SMEs with varying DA:NVP ratios and 2.5% AcP applied to aluminum in accordance with various embodiments of the present disclosure.

FIG. 13C exemplarily depicts adhesion strength of exemplary biocompatible adhesive SMEs with 1:1 DA; NVP ratios and 2.5% AcP on pig skin, aluminum, glass, polyethylene and polyimide films in accordance with various embodiments of the present disclosure.

FIG. 13D exemplarily depicts the interfacial toughness of exemplary biocompatible adhesive SME samples with 2.5% AcP and 1:1 DA:NVP applied to aluminum in accordance with various embodiments of the present disclosure.

FIG. 13E exemplarily depicts the adhesion strengths of biocompatible adhesion SMEs with 1:1 DA:NVP and 2.5% AcP on glass after immersion in water for varying durations in accordance with various embodiments of the present disclosure.

FIG. 13F exemplarily depicts the adhesion strength of exemplary biocompatible adhesive SMEs with 1:1 DA:NVP ratio and different AcP weight ratios applied to aluminum in accordance with various embodiments of the present disclosure.

### DETAILED DESCRIPTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what is believed to be the best mode of carrying out the claimed invention. Additionally, it is to be understood that the claimed invention is not limited in its applications to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

The term “polymer” as used herein is considered to be inclusive of polymers made from a single repeating monomeric subunit as well as what are commonly called “copolymers,” or polymers made from more than one monomeric subunit. The term “copolymer” is used herein specifically to denote polymers made from more than one type of repeating monomeric subunit. The term “elastomer” is a kind of polymer showing high elasticity and stretchability.

The term “shape memory elastomer” (SME) as used herein is a subcategory of “shape memory polymer” (SMP), such that all SMEs are SMPs.

The terms “biocompatible” and “biocompatibility” as used herein refer to a material's ability to perform its intended function on or within a biological system, such as the human body, without eliciting undesirable local or systemic responses such as cell death, impaired cell function, or immune response.

The term “biodegradable” as used herein refers to materials capable of being decomposed by natural biological processes into simpler compounds through the action of human bodies and/or their enzymes under physiological conditions.

The term “glass transition temperature” (T_{g}) as used herein refers to the critical temperature at which a shape memory material undergoes a phase change that enables it to switch between relatively rigid and flexible states.

The term “programmed shape” as used herein refers to the shape that a shape memory material is physically manipulated into holding. Shape memory materials are typically created with an ‘original’ shape, and programming typically involves deforming the material's original shape at elevated temperatures (above a transition temperature) to create a temporary shape that is then fixed by cooling below a transition temperature. The original shape essentially remains stored in the material's molecular structure. When the material is in a programmed shape and is then heated above a transition temperature, the original shape is restored. As detailed below, some materials can have multiple transition temperatures and thus multiple programmed shapes. For example, a material holding a second programmed shape, when heated above a first transition temperature, will assume a first programmed shape, and when further heated above a second transition temperature, will assume its original shape.

The term “shape fixity” as used herein refers to a measure of a material's ability to maintain its programmed temporary shape after any deforming forces are removed and the material is cooled below its transition temperature, typically expressed as a percentage ratio (shape fixity ratio, R_{f}) between the achieved temporary shape and the intended programmed shape.

The term “shape recovery” as used herein refers to a measure of a material's ability to return to its original shape from its temporary shape when heated above its transition temperature, expressed as a percentage (shape recovery ratio, Rᵣ) of the total deformation that is reversed during recovery. The shape recovery of the exemplary SMEs described herein is triggered by internal body heat, but can be done by any means known to one of ordinary skill in the art, including by external magnetic and optical triggers if they form composites.

The term “crosslinking density” as used herein refers to the number of crosslinks (covalent or non-covalent bonds) connecting different polymer chains per unit volume in a polymer network, which determines the average molecular weight between these interconnections and directly influences the material's mechanical properties, swelling behavior, and degradation rate.

The term “hydrophobic” as used herein refers to the tendency of a material or molecular region to repel or minimize interactions with water molecules, typically due to the presence of non-polar groups such as alkyl chains, aromatic rings, or other low-polarity molecular segments.

The term “adhesive” as used herein refers to a substance capable of holding materials together through surface attachment by creating physical and/or chemical bonds between the substrate surfaces, which determines the strength and durability of the bond and directly influences the materials' combined mechanical properties, environmental resistance, and failure mode.

Described herein are shape memory elastomers (SMEs) that function as highly robust adhesives in both wet and dry environments, and which can be printed in any size and shape from the photocurable and extrudable inks. The SMEs described herein exhibit both chemical and physical adhesive properties and can conform to a variety of substrate compositions and topologies. The described SMEs also exhibit tunable mechanical properties, high elasticity and stretchability, and tunable transition temperatures (T_{g}). In some embodiments, the SMEs described herein also exhibit high biocompatibility. Thus, the SMEs described herein are ideal for use as adhesives in wet or dry environments, biological adhesives, suture or patch stopping internal bleeding and isolating organs where blood flow must be restricted, dental applications where water exclusion is critical for curing Resin-Based Composite Fillings, and as components of bioelectronic devices, wearable electronics, and wound healing devices.

The following detailed description begins with description of an adhesive SME described herein that principally comprises a copolymer with three or more monomer residues, referred to as an adhesive SME. This description is followed by a description of adhesive SME embodiments that replace one of the three monomer residues with an oligomeric component for improved stretchability and biocompatibility, referred to as a biocompatible adhesive SME. Both the adhesive SME and the biocompatible adhesive SME are capable of adhering to substrates by taking advantage of both chemical and physical methods of adhesion. The chemical method of adhesion promotes the formation of hydrogen bonds between the described SMEs and a given substrate, where the hydrogen bonds are protected from interference by water and other polar substances by nonpolar domains in the SMEs themselves. The physical method of adhesion is the result of the capacity of the described SMEs to be programmed in a shape that physically conforms to a substrate's surface topography. Methods of preparation for each of the adhesive SME and the biocompatible adhesive SME are provided as well, as are descriptions of exemplary adhesive materials based on the SMEs described herein.

### Adhesive SME

The present disclosure generally provides an adhesive shape memory elastomer (SME) 50 that exhibits high ductility, elasticity, and mechanical strength, and features shape memory behavior observable across a glass transition temperature T_{g} that can be tuned within a range that includes ordinary ambient room temperatures and human skin temperatures. The shape memory behavior of the adhesive SME 50 is particularly important because it allows the adhesive SME to be programmed into a shape that conforms to the topography of a substrate to which the adhesive SME is applied. Thus, the adhesive SME described herein can conform and adhere even to rough, uneven surfaces that typical adhesives struggle to strongly adhere to. In various exemplary embodiments, the adhesive SME 50 is a copolymer comprising a first monomer residue, a second monomer residue, and a third monomer residue, all three of which are mutually crosslinked to form a copolymer network 100. The first monomer residue is a hydrophilic monomer residue with at least one region of relatively negative charge capable of functioning as a hydrogen bond acceptor. The second monomer residue is a monomer residue with a hydrophobic alkyl side chain that provides enhanced material flexibility when polymerized. The third monomer residue is a multifunctional monomer residue with at least one region capable of acting as a hydrogen bond donor. In various exemplary embodiments, the third monomer residue can be considered a crosslinker. In various exemplary embodiments, the third monomer residue comprises amphiphilic functional groups.

In various exemplary embodiments, the first monomer residue is a residue of N-vinylpyrrolidone (NVP), the second monomer residue is a residue of dodecyl acrylate (DA), and the third monomer residue is a residue of 2-hydroxy-3-phenoxypropyl acrylate (HA), all three of which polymerize and mutually crosslink to form the copolymer network, which is a NVP-DA-HA network 100. Molecular structures of NVP, DA, and HA are depicted below as Structure 1, Structure 2, and Structure 3 respectively.

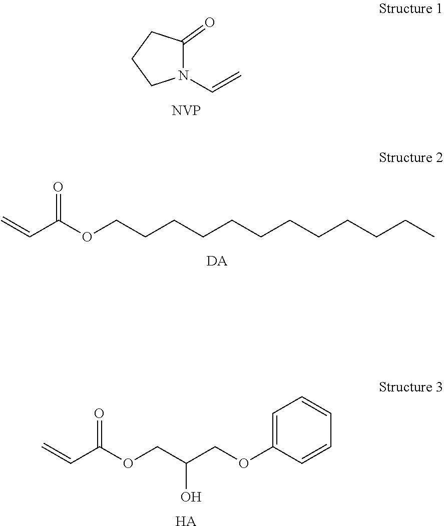

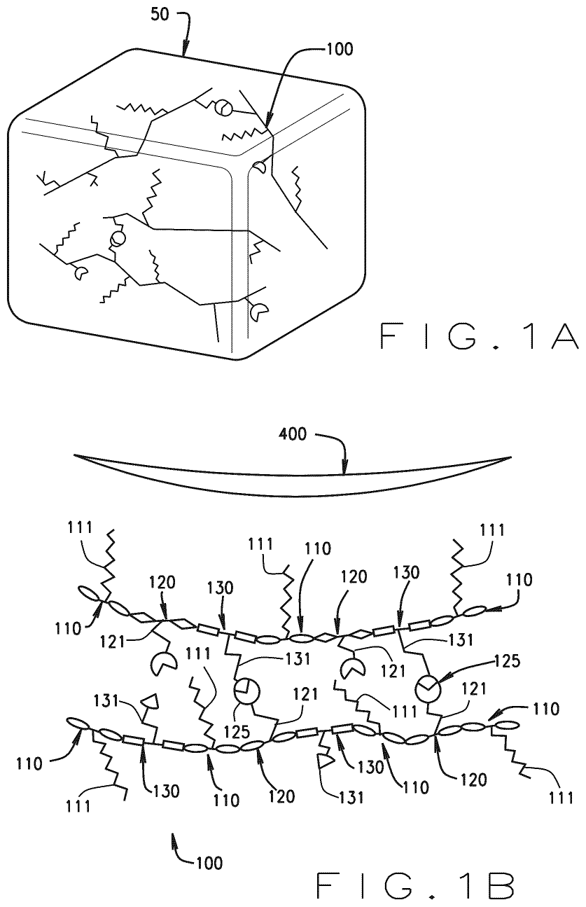

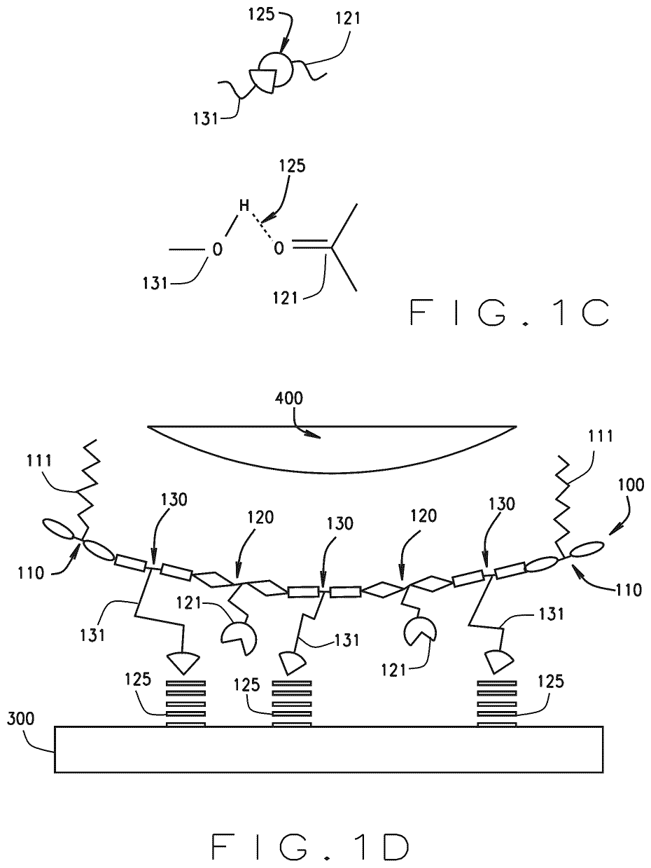

FIG. 1A shows an exemplary depiction of the adhesive SME 50 that comprises the NVP-DA-HA network 100. The NVP-DA-HA network 100 depicted in FIG. 1A is a simplified abstract depiction that is not intended to convey concrete information about the macroscopic structure of the NVP-DA-HA network 100, which varies across the extent of the adhesive SME 50. Similarly, although the exemplary depiction of FIG. 1A shows the adhesive SME 50 having a substantially cubic structure, the adhesive SME 50 can be manufactured to assume nearly any conceivable size and/or shape, including but not limited to strips, circular patches, and other shapes and conformations known to one of ordinary skill in the art.

FIGS. 1B and 1D depict exemplary schematics of the NVP-DA-HA network 100 that defines the physical and chemical properties of the adhesive SME 50. Note that FIGS. 1B and 1D only show representative segments of the molecular structure of the NVP-DA-HA network 100. Besides the covalently bonded structure in SME 50 the polymer chains can form non-covalent interactions (hydrogen bonds). Unlike crystalline materials which have a precise, repeating arrangement, the actual structure of the NVP-DA-HA network 100 varies throughout the adhesive SME 50. FIGS. 1B and 1D illustrate typical bonding patterns and molecular arrangements that occur within the NVP-DA-HA network 100 but should not be interpreted as depicting the exact structure found at every point in the adhesive SME 50. As can be appreciated from FIG. 1B, the NVP-DA-HA network 100 comprises a plurality of DA moieties 110, a plurality of NVP moieties 120, and a plurality of HA moieties 130 connected to one another by both covalent bonds and non-covalent interactions. Covalent bonds are formed between DA, NVP, and HA during polymerization.

Each of the plurality of DA moieties 110 comprises a hydrophobic chain 111. Each of the plurality of NVP moieties 120 comprises an oxocarbon group 121 which contains an oxygen atom that can be anionic or partially negatively charged, making it a strong hydrogen bond acceptor. Each of the plurality of HA moieties 130 comprises a hydroxyl group 131. The hydroxyl group 131 contains a hydrogen atom bound to an electronegative oxygen atom, thereby making the hydrogen atom a strong hydrogen bond donor. As particularly depicted in FIG. 1C, the oxocarbon group 121, being a strong hydrogen bond acceptor, can form a hydrogen bond 125 with the hydroxyl group 131 of any of the plurality of HA moieties 130 that are nearby. The hydrogen bonds 125 formed via interaction of the oxocarbon group 121 and the hydroxyl group 131 strengthen the NVP-DA-HA network 100.

FIG. 1B also depicts how the NVP-DA-HA network 100 provides an effective adhesive by enabling hydrogen bonds while also protecting those hydrogen bonds from being weakened by water in an aqueous environment. A quantity of water 400 is shown in FIG. 1B adjacent to the NVP-DA-HA network 100. Ordinarily, water can interfere with and weaken or break existing hydrogen bonds 125 between other non-water substances such as HA and NVP. However, without being bound by any particular theory, it is believed that the hydrophobic chain 111 on each of the plurality of DA moieties 110 repels water, effectively insulating hydrogen bonds formed by the oxocarbon group 121 and the hydroxyl group 131. Thus, in the exemplary depiction of FIG. 1B, the quantity of water 400 is kept separate from the hydrogen bond-accepting oxocarbon group 121 and the hydrogen bond-donating hydroxyl group 131, leaving each to form and retain hydrogen bonds 125. Furthermore, as shown in FIG. 1D, the oxocarbon group 121 and the hydroxyl group 131 do not just form hydrogen bonds 125 with one another; they can also form hydrogen bonds 125 with an exemplary substrate 300 that is itself capable of forming hydrogen bonds. Thus, use of the hydrophobic chains 111 to insulate the hydrogen bonds 125 from the water 400 also improves the ability of the adhesive SME 50 to adhere to the substrate 300. Although not depicted in FIG. 1B, it is also believed that the hydrophobic chains 111 are capable of directly improving adhesion of the NVP-DA-HA network 50 to the substrate 300 via Van der Waals interactions, electrostatic forces, and similar nonpolar attractive interactions. In sum, the molecular-level interactions described above are constitutive of the chemical method of adhesion exhibited by the adhesive SME 50.

In various exemplary embodiments, the NVP-DA-HA network 100 exhibits a weight ratio of its components of approximately 3.2:1:1 NVP:DA:HA, although a wide range of other ratios of NVP:DA:HA are considered to be within the scope of the present disclosure and are explored in further detail below in the Examples. In various exemplary embodiments, the weight ratio of NVP:DA:HA in the NVP-DA-HA network 100 can be between 99.99:0.01 and 0.01:99.99, including all ratios to a precision of 0.01, as even very small variations in the percentages of NVP and DA can significantly alter the properties of the NVP-DA-HA network 100. In various exemplary embodiments, the weight ratio of NVP:DA:HA in the NVP-DA-HA network 100 can be, without limitation, approximately or exactly 1.0:1.0:1.0, 1.1:1.0:1.0, 1.0:1.1:1.0, 1.0:1.0:1.1, 1.2:1.0:1.0, 1.0:1.2:1.0, 1.0:1.0:1.2, 1.3:1.0:1.0, 1.0:1.3:1.0, 1.0:1.0:1.3, 1.4:1.0:1.0, 1.0:1.4:1.0, 1.0:1.0:1.4, 1.5:1.0:1.0, 1.0:1.5:1.0, 1.0:1.0:1.5, 1.6:1.0:1.0, 1.0:1.6:1.0, 1.0:1.0:1.6, 1.7:1.0:1.0, 1.0:1.7:1.0, 1.0:1.0:1.7, 1.8:1.0:1.0, 1.0:1.8:1.0, 1.0:1.0:1.8, 1.9:1.0:1.0, 1.0:1.9:1.0, 1.0:1.0:1.9, 2.0:1.0:1.0, 1.0:2.0:1.0, 1.0:1.0:2.0, 2.1:1.0:1.0, 1.0:2.1:1.0, 1.0:1.0:2.1, 2.2:1.0:1.0, 1.0:2.2:1.0, 1.0:1.0:2.2, 2.3:1.0:1.0, 1.0:2.3:1.0, 1.0:1.0:2.3, 2.4:1.0:1.0, 1.0:2.4:1.0, 1.0:1.0:2.4, 2.5:1.0:1.0, 1.0:2.5:1.0, 1.0:1.0:2.5, 2.6:1.0:1.0, 1.0:2.6:1.0, 1.0:1.0:2.6, 2.7:1.0:1.0, 1.0:2.7:1.0, 1.0:1.0:2.7, 2.8:1.0:1.0, 1.0:2.8:1.0, 1.0:1.0:2.8, 2.9:1.0:1.0, 1.0:2.9:1.0, 1.0:1.0:2.9, 3.0:1.0:1.0, 1.0:3.0:1.0, 1.0:1.0:3.0, 3.1:1.0:1.0, 1.0:3.1:1.0, 1.0:1.0:3.1, 3.2:1.0:1.0, 1.0:3.2:1.0, 1.0:1.0:3.2, 99:0.5:0.5, 98:1:1, 95:2.5:2.5, 90:5:5, 85:5:10, 85:10:5, 80:5:15, 80:10:10, 80:15:5, 75:5:20, 75:10:15, 75:15:10, 75:20:5, 70:5:25, 70:10:20, 70:15:15, 70:20:10, 70:25:5, 65:5:30, 65:10:25, 65:15:20, 65:20:15, 65:25:10, 65:30:5, 60:5:35, 60:10:30, 60:15:25, 60:20:20, 60:25:15, 60:30:10, 60:35:5, 55:5:40, 55:10:35, 55:15:30, 55:20:25, 55:25:20, 55:30:15, 55:35:10, 55:40:5, 50:5:45, 50:10:40, 50:15:35, 50:20:30, 50:25:25, 50:30:20, 50:35:15, 50:40:10, 50:45:5, 45:5:50, 45:10:45, 45:15:40, 45:20:35, 45:25:30, 45:30:25, 45:35:20, 45:40:15, 45:45:10, 45:50:5, 40:5:55, 40:10:50, 40:15:45, 40:20:40, 40:25:35, 40:30:30, 40:35:25, 40:40:20, 40:45:15, 40:50:10, 40:55:5, 35:5:60, 35:10:55, 35:15:50, 35:20:45, 35:25:40, 35:30:35, 35:35:30, 35:40:25, 35:45:20, 35:50:15, 35:55:10, 35:60:5, 30:5:65, 30:10:60, 30:15:55, 30:20:50, 30:25:45, 30:30:40, 30:35:35, 30:40:30, 30:45:25, 30:50:20, 30:55:15, 30:60:10, 30:65:5, 25:5:70, 25:10:65, 25:15:60, 25:20:55, 25:25:50, 25:30:45, 25:35:40, 25:40:35, 25:45:30, 25:50:25, 25:55:20, 25:60:15, 25:65:10, 25:70:5, 20:5:75, 20:10:70, 20:15:65, 20:20:60, 20:25:55, 20:30:50, 20:35:45, 20:40:40, 20:45:35, 20:50:30, 20:55:25, 20:60:20, 20:65:15, 20:70:10, 20:75:5, 15:5:80, 15:10:75, 15:15:70, 15:20:65, 15:25:60, 15:30:55, 15:35:50, 15:40:45, 15:45:40, 15:50:35, 15:55:30, 15:60:25, 15:65:20, 15:70:15, 15:75:10, 15:80:5, 10:5:85, 10:10:80, 10:15:75, 10:20:70, 10:25:65, 10:30:60, 10:35:55, 10:40:50, 10:45:45, 10:50:40, 10:55:35, 10:60:30, 10:65:25, 10:70:20, 10:75:15, 10:80:10, 10:85:5, 5:5:90, 5:10:85, 5:15:80, 5:20:75, 5:25:70, 5:30:65, 5:35:60, 5:40:55, 5:45:50, 5:50:45, 5:55:40, 5:60:35, 5:65:30, 5:70:25, 5:75:20, 5:80:15, 5:85:10, 5:90:5, 2.5:95:2.5, 1:98:1, 0.5:99:0.5, 5:5:90, 2.5:2.5:95, 1:1:98, and 0.5:0.5:99.

The exemplary ratio provided above of 3.2:1:1 NVP:DA:HA by weight is best understood in recognition of how DA, NVP and HA each affect the physical and chemical properties of the NVP-DA-HA network 100. The following description therefore details how DA, NVP and HA each affect the shape memory behavior, thermomechanical properties, and adhesive merits of the NVP-DA-HA network 100. With this information, the particular properties of the adhesive SME 50 described herein can be tailored to a given application.

Without being bound by any particular theory, it is believed that the primary role of the plurality of DA moieties 110 in the NVP-DA-HA network 100 is to protect the hydrogen bonds 125 generated within the NVP-DA-HA network 100 and between the adhesive SME 50 and the substrate 300, as well as to act as a soft segment in the NVP-DA-HA network 100 that increases fractural strain and thereby improves the mechanical strain tolerance of the adhesive SME 50. Thus, as the relative weight of the plurality of DA moieties 110 in the NVP-DA-HA network 100 increases, the stretchability and fractural strain of the adhesive SME 50 increases, and the adhesive SME 50 shows more recoverable elastic deformation. The effects of increasing relative weight of DA in the NVP-DA-HA network 100 is further explored below in Example 7.

Without being bound by any particular theory, it is believed that the primary role of the plurality of NVP moieties 120 in the NVP-DA-HA network 100 is to enable the hydrogen bonds 125 generated within the NVP-DA-HA network 100 by providing the hydrogen bond-accepting oxocarbon group 121, as well as to act as a hard segment in the NVP-DA-HA network 100 that increases tensile strength and thereby strengthens the adhesive SME 50 and reduces its susceptibility to deformation. An increase in the relative weight of HA moieties 130 in the NVP-DA-HA network 100 also results in an increase the Young's modulus of the adhesive SME 50. The effects of increasing relative weight of NVP in the NVP-DA-HA network 100 is further explored below in Example 7.

Without being bound by any particular theory, it is believed that the primary role of the plurality of HA moieties 130 in the NVP-DA-HA network 100 is to enable the hydrogen bonds 125 generated within the NVP-DA-HA network 100 by providing the hydrogen bond-donating hydroxyl group 131, as well as to act as a hard segment in the NVP-DA-HA network 100 that increases tensile strength and thereby strengthens the adhesive SME 50 and reduces its susceptibility to deformation. The effects of increasing relative weight of NVP in the NVP-DA-HA network 100 is further explored below in Example 7.

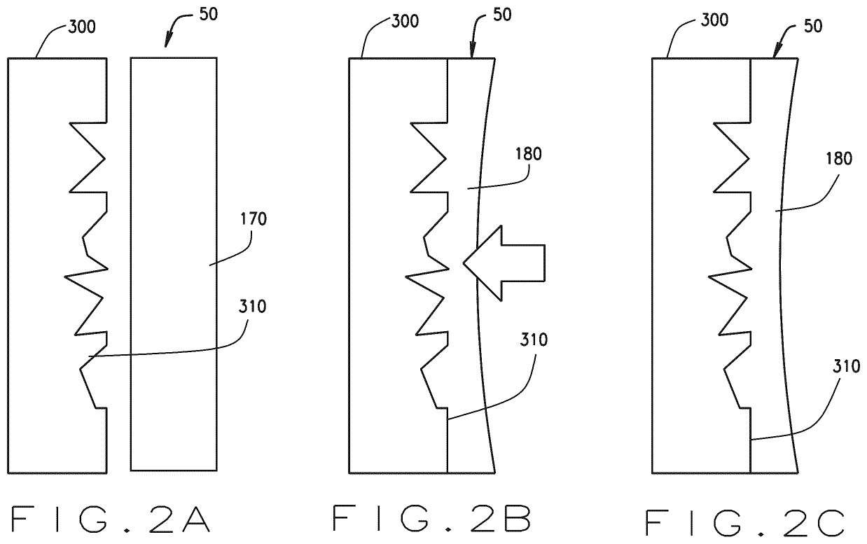

The NVP-DA-HA network 100 exhibits shape memory behavior that enables a greater extent of adhesion to a substrate than is seen in typical adhesives. An exemplary depiction of the shape memory behavior of adhesive SME 50 of the present disclosure is provided in FIGS. 2A-2C. In the exemplary depiction of FIG. 2A, the substrate 300 is an exemplary substrate with a rough surface 310. The exemplary adhesive SME 50 shown in FIG. 2A is manufactured in an original shape 170 that significantly does not conform to the rough surface 310 of the substrate 300. Although the original shape 170 depicted in FIG. 2 is a flat rectangular shape, the original shape 170 can assume a nearly infinite variety of forms, as the original shape 170 is set in the process of manufacturing the adhesive SME 50 itself. Even if the exemplary adhesive SME 50 shown in FIG. 2A were pressed against the rough surface 310, the adhesive SME 50 would not fully conform to the topography of the rough surface 310 so long as the adhesive SME 50 were kept below the glass transition temperature T_{g}. When the original shape 170 of the adhesive SME 50 comprising the NVP-DA-HA network 100 is heated above a transition temperature T_{g}, the adhesive SME 50 undergoes a physical change to assume a more amorphous, programmable form, thereby rendering the adhesive SME 50 capable of deformation. The capability of the NVP-DA-HA network 100 to deformation above T_{g} is demonstrated in FIG. 2B, which shows the adhesive SME 50 heated above T_{g}, being applied with force to the substrate 310. Above T_{g}, the adhesive SME 50 conforms to the topography of the roughened surface 310 and thus assumes a programmed shape 180. Thereafter, as shown in FIG. 2C, the adhesive SME 50 will undergo a return physical change when cooled to a temperature below T_{g}, assume a more rigid and glassy state or structure less susceptible to deformation, but retain the programmed shape 180, greatly increasing the extent of microscopic contact, and thus the adhesion, between the adhesive SME 50 to the substrate 300. The shape memory adhesion mechanism depicted in FIGS. 2A-2C is thus often referred to as the rubbery-to-glass (R2G) adhesion mechanism, as it takes advantage of the ability of the adhesive SME 50 to transition from flexible and deformable ‘rubbery’ (FIG. 2B, temperature above T_{g}) to more rigid and deformation-resistant ‘glass’ (FIG. 2C, temperature below T_{g}) states. In various exemplary embodiments, conformation of the programmed shape 180 to the rough surface 310 can beneficially result in mechanical interlocking of the adhesive SME 50 and the substrate 300, further improving adhesion. As further detailed in Example 8 below, increasing the roughness of the surface of the substrate 300 results in increased adhesion strength to the adhesive SME 50, which is an effect contrary to what is observed in typical adhesives. In sum, the shape programming and mechanical interlocking interactions described above are constitutive of the physical method of adhesion exhibited by the adhesive SME 50.

Two exemplary applications of the adhesive SME 50 are described below. Each exemplary application relies not only on the ability of the adhesive SME 50 to repel water and retain adhesive strength when in contact with water, but also on the robustness of the NVP-DA-HA network 100 against swelling and deforming over long periods of contact with water. In other words, prolonged contact with water does not result in significant swelling of the adhesive SME 50, thereby ensuring that the adhesive SME does not deform and lose contact with the substrate 300. Additionally, both exemplary applications described below benefit from the relatively low T_{g} of the adhesive SME described herein, which in various exemplary embodiments ranges from 17-38° C. and is a function of the weight ratios of DA, NVP, and HA. In having a low T_{g} such as 30° C., the adhesive SME 50 described herein can be applied to a room-temperature substrate and programmed rapidly and easily simply by applying mild heat.

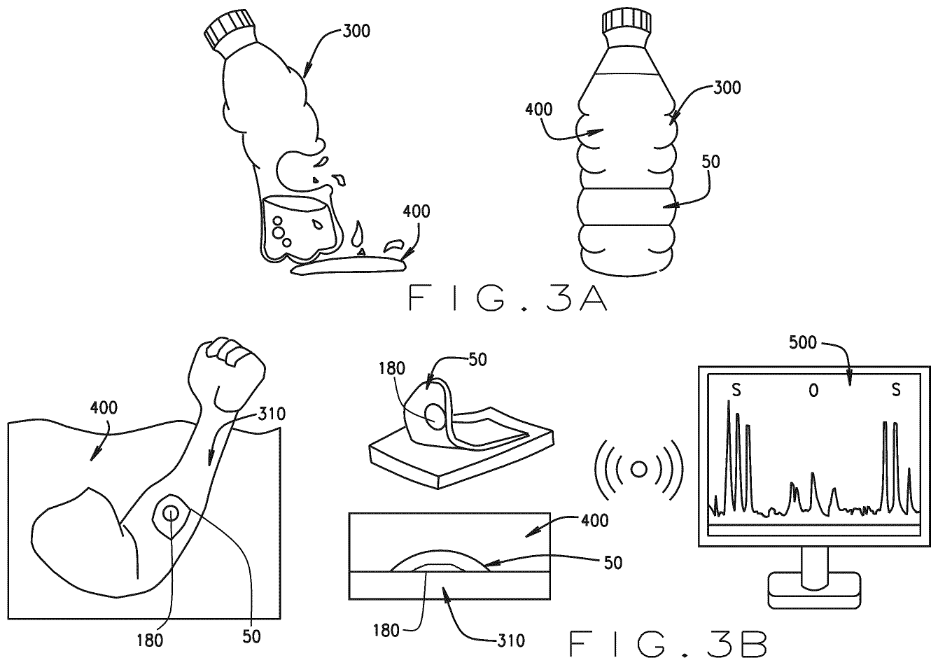

An exemplary application of the adhesive SME as a waterproof adhesive for repair operations is depicted in FIG. 3A. FIG. 3A shows an exemplary bottle as the substrate 300, and a hole in the substrate 300 is permitting water 400 to leak out. In order to prevent leaking, the adhesive SME 50 is applied onto the substrate 300. The adhesive SME 50 can be applied at room temperature and then exposed to mild heat while pressed against the substrate 300, thereby programming the adhesive SME 50 to have a programmed shape that conforms to the surface of the substrate 300. The adhesive strength of the SME 50 is not compromised by constant contact with the water 400 because, as described above, the hydrophobic chains 111 of the plurality of DA moieties 100 repel water and protect the hydrogen bonds 125 in the adhesive SME 50 and the hydrogen bonds 125 between the adhesive SME 50 and the substrate 300.

Another exemplary application of the adhesive SME is depicted in FIG. 3B, which shows how the adhesive SME 50 can be used to affix a biosensor to human skin. A biosensor 180 is nested on one side of an adhesive SME 50, and then the adhesive SME is applied to a human skin substrate 310 such that the biosensor 180 is sandwiched between the human skin substrate 310 and the adhesive SME 50. In various exemplary embodiments, the weight ratio of components in the NVP-DA-HA network 100 is tuned such that the T_{g} of the adhesive SME 50 is higher than that of human skin. In this way, the adhesive SME 50 can be programmed with the application of mild heat while applied to the human skin substrate 310, which will in turn increase the adhesive strength of the adhesive SME 50 once the temperature is cooled below T_{g}. As shown in the exemplary embodiment of FIG. 3B, even when the human skin substrate 310 is immersed in water 400, the adhesive SME 50 covers the biosensor 180, adheres strongly to the skin substrate 310, and blocks the water 400 from contacting the biosensor 180. This exemplary application is particularly important for any biosensor or similar electronic equipment that is sensitive to contact with water.

One of ordinary skill in the art could envision modifications to the above description of the adhesive SME 50 that are considered to be within the scope of the present description. For example, in lieu of DA, the SME 50 can comprise any monomer that is capable of polymerizing to form covalent bonds with other monomers and which features long hydrophobic side chains, including but not limited to octyl acrylate, decyl acrylate, tetradecyl acrylate, hexadecyl acrylate, stearyl acrylate, octyl methacrylate, lauryl methacrylate, stearyl methacrylate, 2-ethylhexyl acrylate, iso-octyl acrylate, and 2-ethylhexyl methacrylate. Similarly, in lieu of NVP, the SME 50 can comprise other monomers that improve the extent of crosslinking through increased hydrogen bonding via hydrogen bond acceptors, including but not limited to acryloylmorpholine, dimethylaminoethyl methacrylate, methacryloyloxyethyl phthalimide, N-acryloylpiperidine, vinyl acetate, acrylonitrile, methyl methacrylate, N-acryloylpyrrolidine, polyvinyl N-vinylcaprolactam, N-vinylacetamide, N-methyl-N-vinylacetamide, N-vinylformamide, 2-vinylpyridine, 4-vinylpyridine, N,N-dimethylacrylamide, N-acryloylmorpholine, 2-vinyloxazoline, acrylamide, and 2-methyl-2-oxazoline. In lieu of HA, one can envision using other monomers that improve the extent of crosslinking through increased hydrogen bonding via hydrogen bond donors, including but not limited to hydroxyethyl methacrylate, hydroxypropyl acrylate, phenoxyethyl acrylate, methacrylic acid, 3-hydroxypropyl methacrylate, acrylamide, N-hydroxyethyl acrylamide, itaconic acid, vinyl alcohol, 2-hydroxyethyl acrylate, 2-hydroxyethyl methacrylate, 2-hydroxypropyl acrylate, 2-hydroxypropyl methacrylate, 3-hydroxypropyl acrylate, 4-hydroxybutyl acrylate, 2-hydroxy-3-phenylpropyl acrylate, 2-hydroxybutyl acrylate, 3-phenoxy-2-hydroxypropyl methacrylate, and glyceryl monoacrylate.

### Biocompatible Adhesive SME

In various exemplary embodiments, the biocompatibility of the adhesive SME 50 can be bolstered by replacing HA with an oligomer residue that has both hydrophobic and hydrophilic segments, and the SME that results from copolymerization of the first monomer residue, the second monomer residue, and the oligomer residue is referred to herein as the biocompatible adhesive SME 60. In various exemplary embodiments, the oligomer residue is a residue of poly(ethylene glycol-co-dodecanedioic acid) diacrylate (AcP) with a linear chain structure. The replacement of HA with AcP in the above-described SMEs can create a network that, while maintaining high material strength from hydrogen-bonds, achieves significantly lower brittleness and higher elasticity. In addition to the covalently bonded structure in SME 60 the polymer chains also form non-covalent interactions (hydrogen bonds). Additionally, the use of AcP in lieu of HA expands the range of T_{g} values in the biocompatible adhesive SME to 10-60° C. and proves to be highly biocompatible. In various exemplary embodiments, the oligomer residue can be considered a crosslinker.

Additionally, AcP is a semi-crystalline oligomer. Incorporating AcP into the biocompatible adhesive SME 60 introduces a second transition temperature T₂ distinct from the glass transition temperature T_{g}, where T₂ corresponds to the melting temperature of the semi-crystalline regions of AcP. Increases in the molecular weight of the AcP oligomer concomitantly increases T₂ while increasing the degree of acrylation decreases T₂. Thus, by carefully balancing the molecular weight of the AcP oligomer and the acrylation degreea semi-crystalline oligomer with a melting temperature around human body temperature can be achieved. Utilizing such an oligomer in the biocompatible SME 60 could be highly relevant for certain biomedical applications.

The biocompatible adhesive SME 60 comprises DA, NVP, and AcP, with AcP having the molecular structure shown below in Structure 4. Acrylated-PEGDDA (AcP) is polymerized from ethylene glycol (EG) and dodecanedioic acid (DDA) and then acrylated by acryloyl chloride.

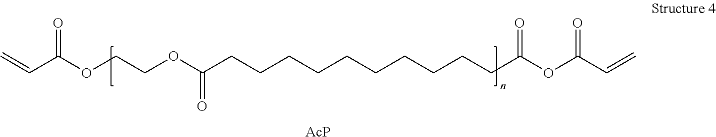

In various exemplary embodiments, the DA, NPV, and AcP are mutually crosslinked to form a DA-NPV-AcP network 101.

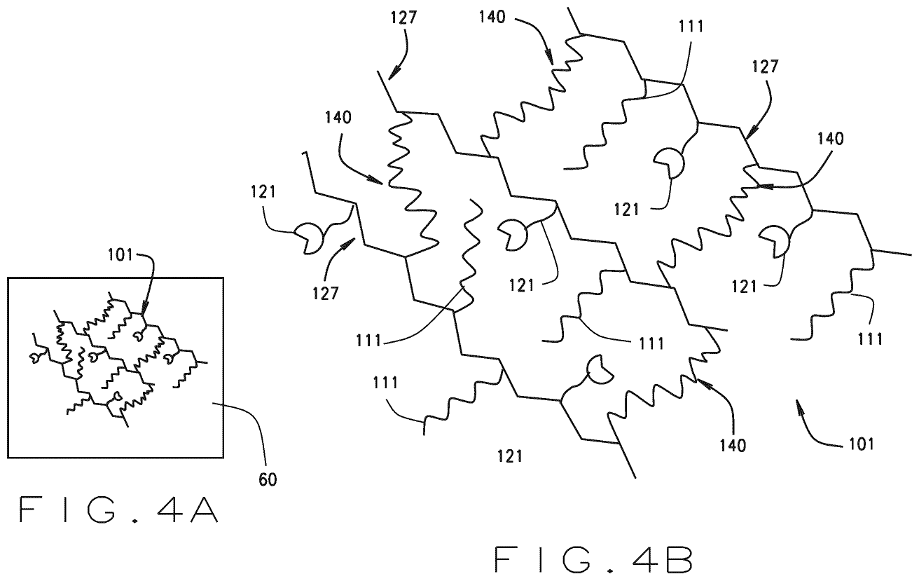

FIG. 4A depicts a biocompatible adhesive SME 60 which comprises the AcP-DA-NPV network 101. FIG. 4B depicts an exemplary schematic of the AcP-DA-NVP network 101. Note that FIG. 4B only shows representative segments of the molecular structure of the AcP-DA-NVP network 101. Unlike crystalline materials which have a precise, repeating arrangement, the actual structure of the AcP-DA-NVP network 101 varies throughout the material. FIG. 4B illustrates typical bonding patterns and molecular arrangements that occur within the AcP-DA-NVP network 101, but should not be interpreted as depicting the exact structure found at every point in the material. As can be appreciated from FIG. 4B, the AcP-DA-NVP network 101 comprises linear polymerized chains 127 that are made from copolymerized DA moieties and NVP moieties. The linear polymerized chains 127 are crosslinked by covalent bonds to a plurality of AcP moieties 140. The resulting AcP-DA-NVP network 101 is thus highly interconnected, resulting in a highly robust and strong biocompatible SME 60.

Additionally, as can be appreciated from the structure of AcP shown above in Structure 4, AcP contains both hydrophobic and hydrophilic structural elements. The oxygen-containing ester functional groups at either end of AcP as shown in Structure 4 are capable of functioning as hydrogen bond acceptors, making them relatively hydrophilic. By contrast, the long alkyl chain that serves to crosslink the linear polymerized chains 127 is hydrophobic. The crosslinking density of the AcP-DA-NVP network 101 is reduced due to the plurality AcP moieties 140, whose long alkyl chains afford the biocompatible SME 60 considerable flexibility, imparting enhanced stretchability to the biocompatible adhesive SME 60.

In various exemplary embodiments, the AcP-DA-NVP network 101 comprises 1:1 weight ratios of DA:NVP as well as 1-10% weight ratios of AcP in the ink. In various exemplary embodiments, the weight ratio of DA:NVP in the AcP-DA-NVP network 101 can be exactly or approximately 1:99, 1:98, 1:97, 1:96, 1:95, 1:94, 1:93, 1:92, 1:91, 1:90, 1:89, 1:88, 1:87, 1:86, 1:85, 1:84, 1:83, 1:82, 1:81, 1:80, 1:79, 1:78, 1:77, 1:76, 1:75, 1:74, 1:73, 1:72, 1:71, 1:70, 1:69, 1:68, 1:67, 1:66, 1:65, 1:64, 1:63, 1:62, 1:61, 1:60, 1:59, 1:58, 1:57, 1:56, 1:55, 1:54, 1:53, 1:52, 1:51, 1:50, 1:49, 1:48, 1:47, 1:46, 1:45, 1:44, 1:43, 1:42, 1:41, 1:40, 1:39, 1:38, 1:37, 1:36, 1:35, 1:34, 1:33, 1:32, 1:31, 1:30, 1:29, 1:28, 1:27, 1:26, 1:25, 1:24, 1:23, 1:22, 1:21, 1:20, 1:19, 1:18, 1:17, 1:16, 1:15, 1:14, 1:13, 1:12, 1:11, 1:10, 1:9, 1:8, 1:7, 1:6, 1:5, 1:4, 1:3, 1:2, 1:1.9, 1:1.8, 1:1.7, 1:1.6, 1:1.5, 1:1.4, 1:1.3, 1:1.2, 1:1, 1.1:1, 1.2:1, 1.3:1, 1.4:1, 1.5:1, 1.6:1, 1.7:1, 1.8:1, 1.9:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, 25:1, 26:1, 27:1, 28:1, 29:1, 30:1, 31:1, 32:1, 33:1, 34:1, 35:1, 36:1, 37:1, 38:1, 39:1, 40:1, 41:1, 42:1, 43:1, 44:1, 45:1, 46:1, 47:1, 48:1, 49:1, 50:1, 51:1, 52:1, 53:1, 54:1, 55:1, 56:1, 57:1, 58:1, 59:1, 60:1, 61:1, 62:1, 63:1, 64:1, 65:1, 66:1, 67:1, 68:1, 69:1, 70:1, 71:1, 72:1, 73:1, 74:1, 75:1, 76:1, 77:1, 78:1, 79:1, 80:1, 81:1, 82:1, 83:1, 84:1, 85:1, 86:1, 87:1, 88:1, 89:1, 90:1, 91:1, 92:1, 93:1, 94:1, 95:1, 96:1, 97:1, 98:1, 99:1.

The exemplary ratio provided above of 1:1 DA:NVP by weight, and 1-10% AcP by weight is best understood in recognition of how the introduction of AcP affects the AcP-DA-NVP network 101. Without being bound by any particular theory, increasing AcP concentration increases the mechanical strength of the AcP-DA-NVP network 101. In various exemplary embodiments, it is up to a maximum of approximately 5% AcP, which is a phenomenon observed in exemplary AcP-DA-NVP networks 101 with 2:1, 1:1, and 1:2 weight ratios of DA:NVP. Additionally, increasing the concentration of AcP increases T_{g}, likely in reflection of the increased stiffness and rigidity of the biocompatible adhesive SME 60. Further details of how changing AcP concentrations affect the biocompatible adhesive SME 60 are explored below in Example 7.

The biocompatible adhesive SME 60 also shows considerable biocompatibility such that in experimental comparisons of in-vitro culturing of C3H10T₁ cells in contact with exemplary biocompatible adhesive SMEs 60 with AcP weight percentages of 1%, 5%, and 10%, there was no significant difference in cell survival between a control group and material co-cultured groups.

The biocompatible adhesive SME 60 in various exemplary embodiments exhibits a chemical method of adhesion similar to that described with respect to the adhesive SME 50. Thus, the biocompatible adhesive SME 60 can adhere to the substrate 300 chemically via covalent and non-covalent interactions with the substrate 300, including hydrogen bonds that are protected from interference by water and other polar substances due to the presence of significant nonpolar domains in the biocompatible adhesive SME 60. The biocompatible SME 60 in various exemplary embodiments can also adhere to the substrate 300 physically via utilization of a programmed shape that mechanically interlocks with the substrate 300.

One of the ordinary skill in the art could envision modifications to the above description of the adhesive SME 50 that are within the scope of the present description. For example, in lieu of AcP, one can envision using other oligomer components that improve the extent of crosslinking through increased hydrogen bonding via hydrogen bond donors, including but not limited to poly(ethylene glycol-co-sebacic acid) diacrylate, poly(ethylene glycol-co-adipic acid) diacrylate, Poly(ethylene glycol-co-suberic acid) diacrylate, Poly(ethylene glycol-co-glutaric acid) diacrylate poly(propylene glycol-co-dodecanedioic acid) diacrylate, Poly(propylene glycol-co-adipic acid) diacrylate, Poly(propylene glycol-co-suberic acid) diacrylate, Poly(propylene glycol-co-azelaic acid) diacrylate, poly(ethylene glycol-co-octadecanedioic acid) diacrylate, poly(ethylene glycol-co-azelaic acid) diacrylate, poly(diethylene glycol-co-dodecanedioic acid) diacrylate, poly(tetramethylene glycol-co-dodecanedioic acid) diacrylate, poly(ethylene glycol-co-undecanedioic acid) diacrylate, poly(propylene glycol-co-sebacic acid) diacrylate, and poly(ethylene glycol-co-hexadecanedioic acid) diacrylate, Poly(diethylene glycol-co-adipic acid) diacrylate, Poly(diethylene glycol-co-hexadecanedioic acid) diacrylate, Poly(tetramethylene glycol-co-sebacic acid) diacrylate, Poly(tetramethylene glycol-co-octadecanedioic acid) diacrylate, Poly(hexamethylene glycol-co-dodecanedioic acid) diacrylate, Poly(hexamethylene glycol-co-sebacic acid) diacrylate, Poly(hexamethylene glycol-co-adipic acid) diacrylate Poly(ethylene glycol-co-maleic acid) diacrylate, Poly(ethylene glycol-co-fumaric acid) diacrylate, Poly(ethylene glycol-co-succinic acid) diacrylate, Poly(propylene glycol-co-maleic acid) diacrylate, Poly(diethylene glycol-co-suberic acid) diacrylate, Poly(neopentyl glycol-co-dodecanedioic acid) diacrylate, Poly(neopentyl glycol-co-sebacic acid) diacrylate.

### SPECIFIC EXAMPLES

### Example 1: Materials and Methods

For NVP-DA-HA adhesive SMEs, 2-Hydroxy-3-phenoxypropyl acrylate (HA), N-Vinylpyrrolidone (NVP, >99%), and dodecyl acrylate (DA, >90%) were purchased from Sigma Aldrich (St. Louis, MO, U.S.). Diphenyl(2,4,6-trimethylbenzoyl) phosphine oxide (TPO, >97%) was purchased from Fisher Scientific (Pittsburgh, PA, U.S.). These materials were used without further purification.

Synthesis of Acrylated-PEGDDA (AcP). Acrylated-PEGDDA prepolymer or oligomer was synthesized by following the steps. Briefly, in a three-necked flask, ethylene glycol (EG) and dodecanedioic acid (DDA) were mixed at a 1:1 molar ratio and heated to 120° C. under nitrogen flow with continuous magnetic stirring. Since this is a polyesterification synthesis, the reaction duration and temperature can affect the molecular weight and melting point. For instance, a 12-hour reaction at 120° C. produced poly(ethylene glycol-dodecanedioic acid) (PEGDDA) with a number-average molecular weight (Mₙ) of 906 g/mol, a weight-average molecular weight (M_{w}) of 1277 g/mol, and a melting point of 75° C. Extending the reaction to 24 hours at the same temperature resulted in Mₙ=1563 g/mol, M_{w}=2775 g/mol, and a melting point of 77° C. Increasing the temperature to 155° C. for 12 hours led to a higher Mₙ of 2257 g/mol, M_{w} of 4407 g/mol, and a melting point of 85° C. At 24 hours under 155° C., the molecular weight increased further (Mₙ=3403 g/mol, M_{w}=8539 g/mol) with a melting point of 86° C. Finally, extending the reaction time to 48 hours at 155° C. yielded PEGDDA with Mₙ=7708 g/mol, M_{w}=13600 g/mol, and a melting point of 87° C. The oligomer with the lower melting point was needed for this work, so the one with Mₙ of ˜ 1 k was chosen. To synthesize acrylated-PEGDDA (AcP), PEGDDA underwent acrylation using acryloyl chloride. Specifically, 15 g of PEGDDA was dissolved in 150 mL of dichloromethane in a 500 mL round-bottom flask. The reaction mixture was supplemented with 0.075 g of 4-methoxyphenol (as an inhibitor), 0.15 g of DMAP, and triethylamine (TEA) in a 1:1 molar ratio with acryloyl chloride. The solution was cooled to 0° C. under nitrogen flow for 10 minutes before the dropwise addition of acryloyl chloride, pre-diluted in dichloromethane (10× its volume), at a 1:3.7 molar ratio relative to the hydroxyl groups of PEGDDA. The reaction vessel was sealed with aluminum foil and stirred at room temperature for 12 hours. Following this, an additional 0.075 g of 4-methoxyphenol was introduced to inhibit unwanted polymerization. The reaction mixture was then concentrated using a rotary evaporator to remove dichloromethane and subsequently dissolved in 75 mL of ethyl acetate. To separate the AcP product from the triethylamine salt byproduct, the solution was centrifuged at 10,000 rpm for 10 minutes. The supernatant was collected and then dried in a rotary evaporator, yielding purified AcP.

For synthesizing AcP-DA-NVP SMEs, raw chemicals of 4-Dimethylaminopyridine (DMAP, 99%), Glycerol (>99.5%), dodecanedioic acid (DDA, 99%), triethylamine (TEA) (>99%), Dichloromethane (>99.8%), and acryloyl Chloride (>97%) were purchased from Sigma-Aldrich (St. Louis, MO, USA). Ethyl acetate (99.5%), diphenyl(2,4,6-trimethylbenzoyl) phosphine oxide (TPO, >98%), and acrylic acid (AA, 98%) were purchased from Fisher Scientific (Pittsburgh, PA, USA). 10-Undecenoic acid (UA) (98%) was purchased from TCI. 4-methoxyphenol (99%) was purchased from Acros Organics. These materials were used without further purification.

### Example 2: Ink Preparation and Photocuring

For the adhesive SME 50, DA, HA, and NVP were mixed at weight ratios of 2:1:1 as a control sample, referred to herein as an ‘ink’ because it can be used to print an SME. When the effect of a monomer weight ratio on the material properties was studied, two of these monomers were fixed while the third one was increased in an incremented weight of 10% of the ink. For example, when studying the effect of the DA weight ratio, the weight ratio of HA and NVP was kept as 1:1, and the DA weight ratio versus HA or NVP was increased from 2.0 to 2.4, 2.8, and 3.2. The obtained samples were named as DA-2.0, DA-2.4, DA-2.8, DA-3.2, respectively. The samples of HA-1.0, HA-1.4, HA-1.8, and HA-2.2 refer to the ones with the DA-HA-NVP ratios of 2:1:1, 2:1.4:1, 2:1.8:1, and 2:2.2:1, respectively. The samples of NVP-1.0, NVP-1.4, NVP-1.8, and NVP-2.2 refer to the ones with the DA-HA-NVP ratios of 2:1:1, 2:1:1.4, 2:1:1.8, and 2:1:2.2, respectively. All the resins were added with a photoinitiator, diphenyl(2,4,6-trimethylbenzoyl) phosphine oxide (TPO) (2 wt %). The ink was photocured by UV-light with an irradiation wavelength of 405 nm under a power density of ˜5 mW/cm². The exposure time was set to 1 min. Then, the photocured objects were post-cured in a 405-nm UV light oven for 6 min.

After that, aluminum foil was used to seal the reaction vessel, which was then stirred at room temperature (T_{R}). After reaction for 12 hours, additional 0.1 g of 4-methoxyphenol was added. The solution was dried in a rotary evaporator by removing the dichloromethane, after which it was then dissolved in 100 mL of ethyl acetate. The supernatant was first dried in a rotary evaporator and then further dried for three days in a vacuum chamber. To separate the solubilized pre-PGDA from the triethylamine salt by-product, the mixture was centrifuged at 10,000 rpm for 10 minutes. For the biocompatible adhesive SME 60, PEGDDA prepolymer or oligomer was synthesized by following a similar way reported in our previously reported works for PGD synthesis. Briefly, in a three-necked flask, ethylene glycol and DDA were mixed at a 1:1 molar ratio and heated to 120° C. under nitrogen flow with continuous magnetic stirring. The reaction for 12 hours in an oil bath yielded PEGDDA with molecular weights of 906 and 1277 g/mol (Mₙ/M_{w}). To synthesize acrylated-PEGDDA (AcP), PEGDDA underwent acrylation using acryloyl chloride. Specifically, 15 g of PEGDDA was dissolved in 150 mL of dichloromethane in a 500 mL round-bottom flask. The reaction mixture was supplemented with 0.075 g of 4-methoxyphenol (as an inhibitor), 0.15 g of DMAP, and triethylamine (TEA) in a 1:1 molar ratio with acryloyl chloride. The solution was cooled to 0° C. under nitrogen flow for 10 minutes before the dropwise addition of acryloyl chloride, pre-diluted in dichloromethane (10× its volume), at a 1:3.7 molar ratio relative to the hydroxyl groups of PEGDDA. The reaction vessel was sealed with aluminum foil and stirred at room temperature for 12 hours. Following this, an additional 0.075 g of 4-methoxyphenol was introduced to inhibit unwanted polymerization. The reaction mixture was then concentrated using a rotary evaporator to remove dichloromethane and subsequently dissolved in 75 mL of ethyl acetate. To separate the AcP product from the triethylamine salt byproduct, the solution was centrifuged at 10,000 rpm for 10 minutes. The supernatant was collected and then dried in a rotary evaporator, yielding purified AcP.

DA and NVP were mixed at DA:NVP weight ratios of 2:1, 1:1, 1:2, and then AcP with weight percentage of 1%, 2.5%, 5%, 10% was added into these DA:NVP solutions under magnetic stirrer at temperature of 70° C. to prepare a homogeneous solution. The photoinitiator diphenyl(2,4,6-trimethylbenzoyl) phosphine oxide (TPO) was added to the AcP-DA-NVP resin at a weight concentration of 3%. After all components were homogeneously mixed, the resin was poured into the in-built vat of a commercial printer. The samples were printed at an irradiation wavelength of 405 nm, exposure 50 (mJ/cm²). The layer thickness was set to 30 μm. The printed samples were detached from the collector, washed with isopropanol for removing the unreacted resin, and finally post-cured by 405 nm UV light for 10 min.

### Example 3: Materials Characterization

For the adhesive SME 50, the viscosity of ink was evaluated by a modular rotation and interface rheometer MCR302 equipped with a C60/2°. The test was performed at room temperature with shear rates changing from 0.1 to 100 l/s. The glass transition temperature (T_{g}) of the polymer was obtained from differential scanning calorimetry (DSC) and dynamic mechanical analysis (DMA). DSC was monitored by using a DSC Q20 machine (TA Instruments, Newcastle, DE, USA). Samples with a weight of ˜15 mg was placed in a standard aluminum crucible with a lid and were scanned in a dynamic mode from −10 to 100° C. at a heating rate of 10° C./min under N₂ atmosphere (30 mL/min). DMA (testing sample: 50 mm length, 5 mm width) test was performed on a DMA 7100 machine (Hitachi, Chiyoda, Tokyo, Japan). Measurement was conducted from −10 to 100° C. in a tensile mode. The heating rate was 3° C./min and the frequency was 1 Hz. SEM images were collected using a Thermoscientific Volumescope at an accelerating voltage of 5.0 kV. The samples were coated with a thin gold film (10 nm) before imaging. The optical images were obtained by Amscope FMA050. The tensile testing was conducted on a Mark-10 universal testing machine at a moving rate of 50 mm/min. Cyclic tensile tests were conducted at a strain of ˜80% of elongation at break at a crosshead speed of 50 mm/min. There was no waiting time between consecutive cycles (1st to 5th cycle). After five cycles, the samples were allowed to relax with a heat gun at the 6th cycle.

For the biocompatible adhesive SME 60, to calculate the acrylation degree, proton nuclear magnetic resonance (1H NMR) was used. The data was recorded at room temperature using a Bruker Avance III 500 MHz spectrometer with tetramethylsilane (TMS) and chloroform-d serving as the internal reference and solvent with a peak at 7.27 ppm, respectively. Chemical shifts were reported in ppm. To calculate the acrylation degree, the peaks of the vinyl groups at shifts in 5.5-6.5 ppm and methylene groups of dodecanedioic acid in 1.6-2.3 ppm were integrated, and then calculated by using following equation:

$$Acrylation Percentage = \frac{{Mol}_{Acr}}{{Mol}_{PEGDDA}} \times 100 = [ \frac{\frac{{Area}_{Acr Peak}}{\# of {Protons}_{Acr Peak}}}{\frac{{Area}_{PEGDDA Peak}}{\# of {Protons}_{methylene Peak}}} ] \times 100$$

Where the number of protons of Acr peak is 6, and the number of protons of methylene peak is 4. A Thermo Nicolet 380 FTIR spectrometer with DIAMOND ATR was used to collect FTIR spectra. Differential Scanning calorimetry (DSC) measurements were taken with TA Instruments (Q-600). In the measurement, the temperature was decreased to −30° C. followed by ramping from −30 to 100° C. at a constant rate of 10° C. min⁻¹.

### Example 4: Mechanical and Adhesion Testing

For the adhesive SME 50, the adhesive was sandwiched between two pieces of selected substrates in water or stored in water for different durations. Then, the adhered plates were clamped into a Mark-10 universal testing machine and pulled at a crosshead speed of 50 mm/min. The adhesion strength was calculated by dividing the measured maximum load by the bonded area. Four measurements were made for each type of the SME 50 samples (as described above, sometimes referred to herein as SMP samples). To test water absorption in the SMP samples were first dried in an oven at 50° C. for 3 h, then sealed in a plastic bag. After it was cooled to room temperature they were weighed to obtain the dry weight of the sample (m₀). The samples that were soaked in distilled water for various duration were then dried with a tissue paper, finally weighed to get average actual sample weight (m). The difference of m and m₀ is the absorbed water weight for each sample.

For the biocompatible adhesive SME 60, Tensile tests were performed on a Mark-10ESM303 universal testing apparatus. Printed ASTM-D638 Type IV dog bone shape specimens were used for tensile testing. The initial length of the samples was 13.5 mm. The measurement was taken at a strain rate of 50 mm/min. The cross-sectional dimensions of each sample were measured using a digital caliper for calculating the cross-sectional areas. For each set of experiments, three samples were tested at room temperature to get statistical results, and stress-strain curve's results were used to calculate the mechanical properties of the samples. Storage modulus and tangent delta were measured using Hitachi Dynamic Mechanical Analyzer (DMA7100) on the printed rectangular samples with dimensions of 20 mm×8 mm×1 mm.

For the sheer test, each sample was sandwiched between two pieces of selected substrates, then prepared samples were clamped into a Mark-10ESM303 universal testing machine and pulled at a crosshead speed of 50 mm/min. The adhesion strength was calculated by dividing the measured maximum load by the adhered area. Three measurements were made for each ratio. For T-peeling test, rectangular thin sheets were prepared and adhered to aluminum foils. The other sides of the sample and aluminum foil were clamped into the testing machine and pulled at a crosshead speed of 50 mm/min. To maximize the measurement accuracy, a straight horizontal line was used to choose an average force.

### Example 5: Biocompatibility Testing

Co-culturing with pluripotent mesenchymal progenitor C3H10T1/2 cells was used to test the cytocompatibility of the SMPs (e.g., SME 50 and/or SME 60). Dulbecco's Modified Eagle Medium (DMEM) supplemented with 10% fetal bovine serum was used to grow the cells. To see how the SMPs affected C3H10T1/2 cell growth, 5×10⁴ cells were seeded in a 6-well plate containing sterile SMP circular discs. Before loading the SMP discs into the culture medium, they were post cured for 30 minutes, then soaked in PBS for 48 hours to remove any unreacted monomers, followed by sterilization in ethanol. Images of cells in each group were captured using a Nikon microscope after each day of culturing continuously for 4 days. Cells were dissociated with trypsin and counted using a Bio-Rad TC10 Automated Cell Counter.

### Example 6: FEA Simulation of R2G Adhesion Mechanism

COMSOL Multiphysics was used to simulate the SMP (e.g., SME 50 and/or SME 60) when adhered to surfaces with three different roughness levels. To reduce the computational cost, 3D elasticity problem was reduced to a 2D plane strain elasticity problem with thickness of 1 cm. The roughness was simulated by a sinuous function⁴⁵ with an amplitude of A and a wavelength of 0.6 cm. The material of the laps is a steel with Young's modulus being 210 GPa, Poisson's ratio 0.3, and mass density 7800 kg/m₃. The SMP adhered to the two laps was simulated as a Mooney-Rivlin model with C10=1.5 MPa, C₀₁=0.4 MPa, and a bulk modulus κ=100 MPa. The left side was fixed while the right side was applied by a horizontal displacement. The interfaces between SMP and laps were modeled as the contact pairs, where adhesion was formulated by the penalty method with the penalty factor (adhesive stiffness) of 20 GN/m₃. For the decohesion process, displacement-based damage model was used to simulate the split of the SMP and laps. In the simulation, tensile strength σₜ=2 MPa, shear strength σₛ=3 MPa, tensile energy release rate G_{ct}=1130 J/m₂, shear energy release rate G_{cs}=1800 J/m₂ were selected. The power law (exponent equals to 1) used the fracture mode criterion to study the crack evolution. To solve the nonlinear equations, the double dogleg method with a maximum number of 250 iterations was used.

### Example 7: Testing Mechanical Properties

### Adhesive SME 50

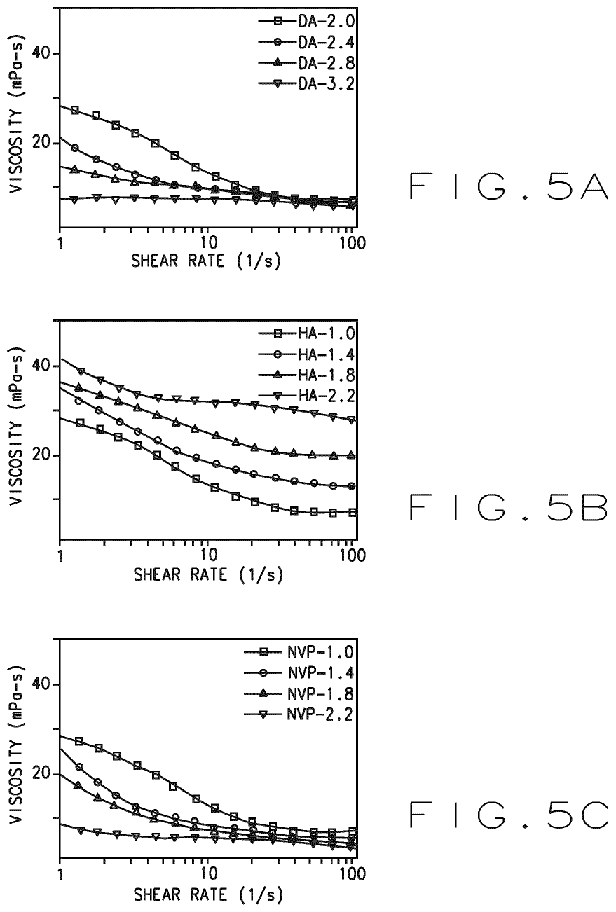

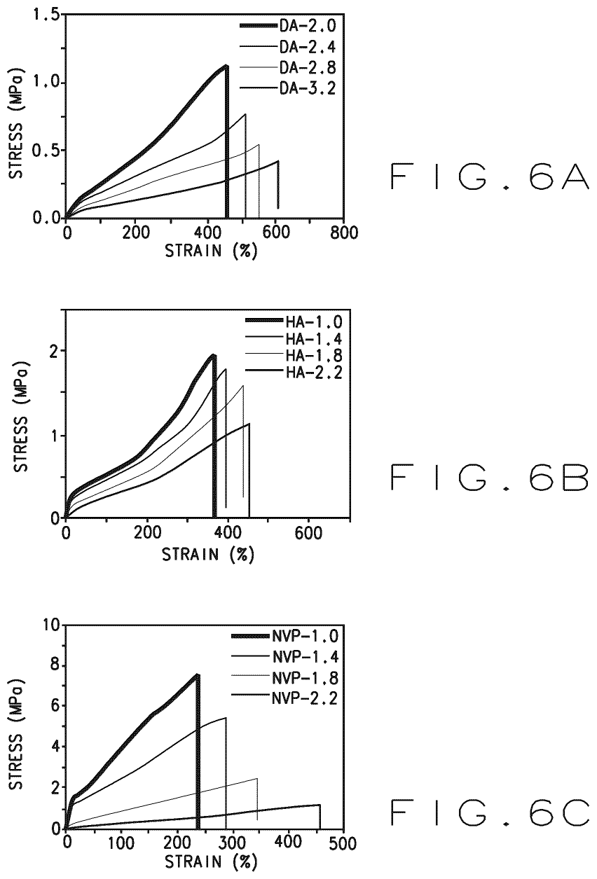

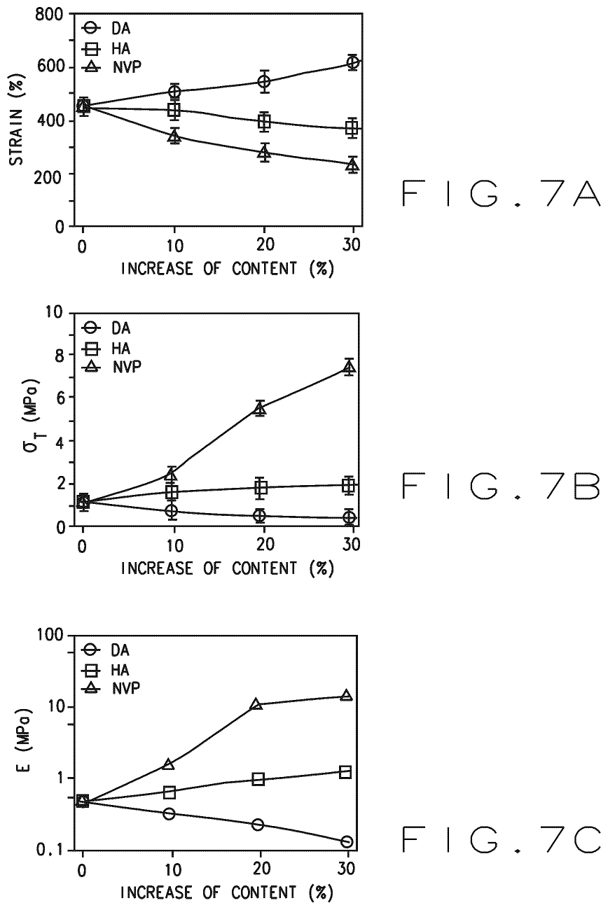

For the adhesive SME 50, the adhesive is a thermoplastic polymer, and the mechanical properties and T_{g} can be tuned simply by weight ratios of the soft and hard monomer residues. To study the respective effects of the three monomer residues, a weight ratio of 2:1:1 for DA, HA, and NVP was used as a reference. To vary the mechanical properties and T_{g} of the SMPs (e.g., SME 50), the ratios of the two monomer residues were fixed and the third one was tuned. For instance, the samples named DA-2.0, DA-2.4, DA-2.8, DA-3.2 refer to the ones synthesize with DA, HA, and NVP weight ratios of 2:1:1, 2.4:1:1, 2.8:1:1, and 3.2:1:1, respectively. It was found that as the weight ratio was tuned, the viscosity of the ink varies in a range of 0.007-0.041 Pa·s (FIGS. 5A-5C). The low viscosity of <1.3 Pas would facilitate the photopolymerization²². Interestingly, the viscosity increases with increase of the weight ratios of the HA monomer residue (FIG. 5A). This could be caused by the hydroxyl groups existing in HA. As the HA ratio increases, the hydrogen interactions increase. It was found that mechanical properties of the SMPs depend on the weight ratios of the soft and hard monomer residues. The tensile test shows that the SMPs show a plastic-to-rubber transition behavior (FIGS. 6A-6C). The stress-strain curves show plastic-like behavior in the beginning. After the yield, the plastic-like behavior is transitioned to a rubber-like one, showing a rapidly increased stress, and is finally followed by fracture, thus resulting in a high ductility. DA's chain is long and acts as a soft segment in the polymer network, making fractural strain of the synthesized material increase from 451% to 614% when the DA's weight ratio to HA and NVP increases from 2.0 to 3.2 (FIG. 7A). HA has rich the hydroxyl groups that make the synthesized polymer chains form H-bonds, thereby increasing the tensile strength of the SMPs from 1.14 to 1.96 MPa when the weight ratios of HA increases from 1.0 to 2.2 (FIG. 7B), while maintaining a fractural strain of 369% (FIG. 7A). Due to its rigid molecule structure, NVP acts as a hard segment in the polymer network. As its weight ratio increases from 1 to 2.2, the tensile strength of the materials is significantly improved from 1.14 to 7.47 MPa (FIG. 7B). The Young's module is increased from 0.49 to 14.61 MPa (FIG. 7C).

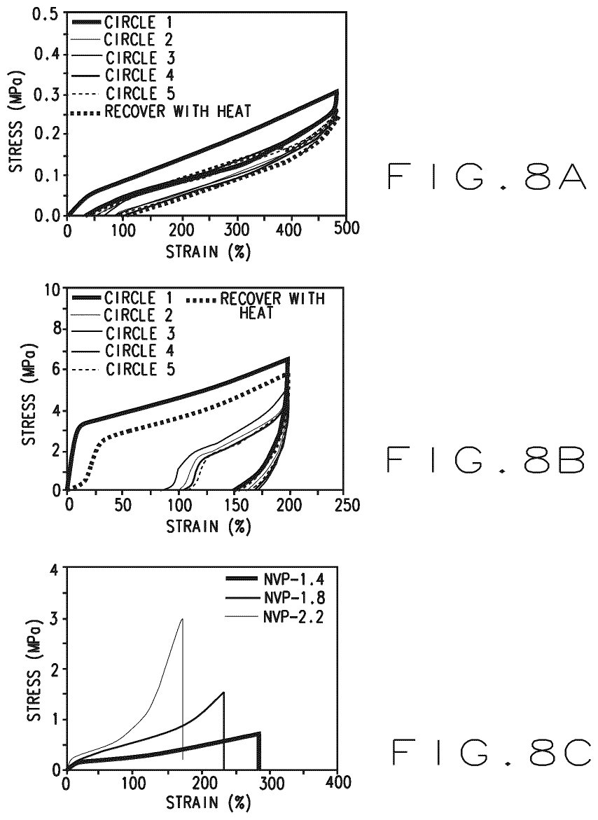

To study the recovery performance, cyclic tensile testing was performed on the DA-3.2 and NVP-2.2 samples (FIG. 8A-8C). A hysteresis loop is seen in the cyclic curves, indicating great energy dissipation capability, which benefits energy absorption from external loading. As the polymer chains can move more freely above the T_{g}, the intermolecular forces would be reduced, thus decreasing their mechanical strength. The results show that the adhesives have significant residual strain accompanied by a decrease in strength after a continuous circulation at a strain of ˜80% of the fractural strain. As shown in FIG. 8A, DA-3.2 shows more recoverable elastic deformation than NVP-2.2 does properly because of the flexibility of the long chains in DA. NVP-2.2 showing a larger residual strain. Nevertheless, the residual strains of both samples can be almost recovered after being heated up to ˜70° C. It could be because the flexibility of the thermoplastic network can easily relax the internal residual stress. To avoid a catastrophic loss of the strength above T_{g} caused by the hyperactive polymer segments, the NVP-2.2 samples that exhibit high tensile strength were selected to evaluate the mechanical behavior (FIG. 8C). It shows that above T_{g} the NVP-2.2 samples still retain a considerable tensile strength of 3.01 MPa and a fractural strain of 281%, respectively. This comparison study illustrates that NVP as a hard segment imparts strength to the adhesives, making it more difficult to deform, while DA as a soft segment improves the stretchability of the adhesives. Thus, combination of these soft and hard monomer residues with different ratios in the ink imparts the synthesized SMP with high tunability in mechanical properties.

T_{g} of the materials was measured by dynamic mechanical analysis (DMA). The DMA curves indicate that as the temperature increases above T_{g}, the storage modulus of the materials decreases exponentially, indicating a transition from a glassy state to a rubbery state. Dependence of T_{g} on the content of DA, HA, and NVP was derived. It shows that as the weight ratio of DA increases, T_{g} decreases from 22 to 17° C. It can be attributed to the effect of the long, soft fatty acid chains. In contrast, as the weight ratios of HA, NVP increase, T_{g} increases from 22 to 29° C. and from 22 to 38° C., respectively. That could be because the ring structures in HA and NVP as well as the formed H-bonds by HA increase the rigidity and lower the motion of the polymer chains. To optimize the shape memory performance at different temperatures, the weight ratios of the monomer residues can be varied accordingly. For example, an NVP-2.2 strip was programmed to a temporary shape at a maximum strain of ˜200% at 70° C. This programmed shape was then fixed below T_{g}, and then recovered to its original shape when heated above T_{g} (Video S2). Moreover, the shape fixing and recovery ratios were also studied. In the test, the SMPs were first applied with a programmed strain (εₚ) of 100% above T_{g}. Then, the temperature was gradually lowered below T_{g} while keeping the material isothermally at 100% strain for 2 min. The retained strain εᵤ was obtained after removing the external load. Then temperature was raised above T_{g}, the shape was recovered. The residue strain & was measured. The shape fixing ratio R_{f}=εᵤ/εₚ and recovery ratio Rᵣ=(εᵤ−εᵣ)/au were calculated. Their dependences on the weight ratios of the three monomer residues were quantified. Thanks to the flexible linear chains, the SMPs maintain >95% of Rᵣ. Although R_{f} values vary with the change of the weight ratios of the monomer residues, they still show >90%. In contrast to HA and NVP, the long fatty acids chains in DA promote chain flexibility, which reduces the R_{f} values as the DA ratio increases. This is consistent with the phenomenon showing a smaller residual strain in the SMPs with high DA weight ratios (FIG. 8A-8B).

### Biocompatible SME 60

For swelling test measurement, from each ratio 3 a sample was printed in circular shape (diameter 7 mm, height 1 mm) and has been immersed in 50 m₁ PBS solution and kept in incubator in 37° C. PBS solution has been changed every two days. For weight loss, the samples and condition of the test were the same, while for measuring the weight loss percentage, after removing samples from PBS, they were washed with deionized water, then were dried in an oven under 50° C. for a day.

### Example 8: Adhesion Performance Testing

### Adhesive SME 50

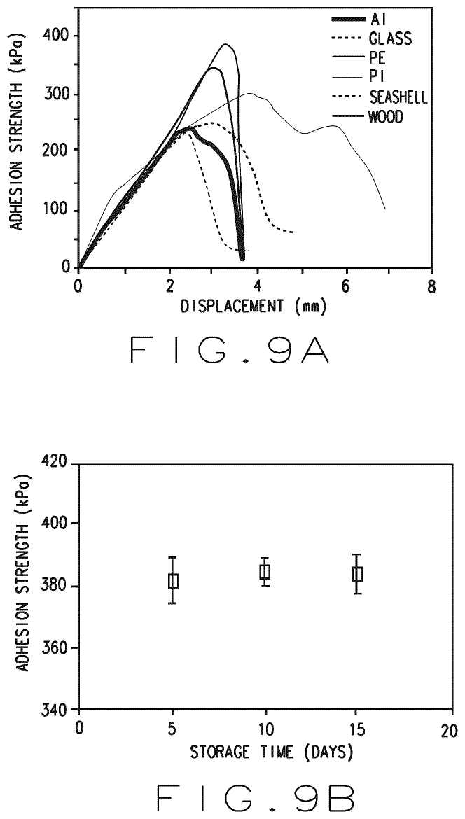

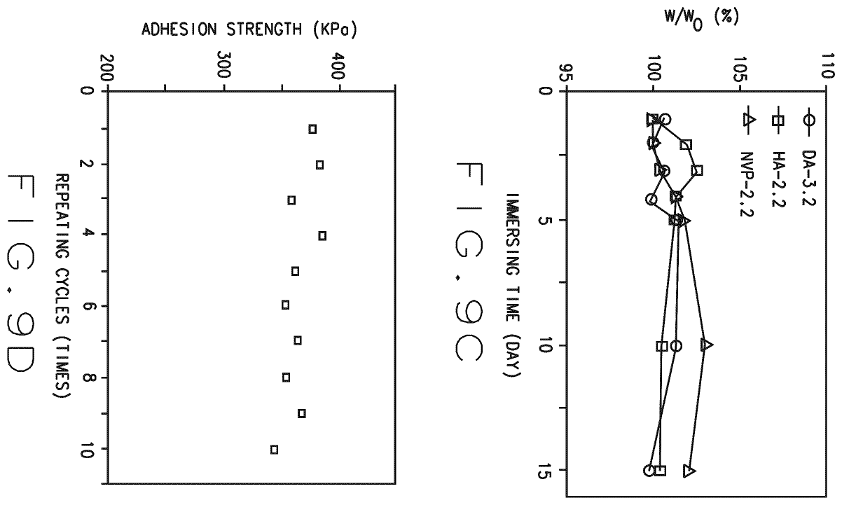

This developed SMP adhesive (e.g., SME 50 and SME 60) exhibits considerable adhesion strength to different types of substrates owing to its microstructure and the R2G adhesion mechanism. In its rubbery state, the polymer chains facilitate formation of hydrogen bonds with the substrates. For example, a DA-3.2 sample with T_{g} of 17° C., which remains a rubbery state at room temperature, exhibits adhesion to surfaces of seashell, wood, plastics (polyethylene (PE), polyimide (PI)), glass, and aluminum (Al). Shear tests were then conducted to measure adhesion strength between the adhesive and these substrates. Stress-strain curves in FIG. 9A show that the adhesion strength to all the substrates is greater than 200 kPa, with those adhered to PE and PI being close to 400 kPa. In addition, the contact angles increase from 68.2 to 78.4° C. with the increased weight content of DA. This hydrophobic property empowers the material with great water repulsion capability. As shown in FIG. 9C, the water uptake of the SMP adhesives is negligible after being soaked in water for 15 days. This great hydrophobicity can at least partially explain why the hydrophilic hydrogen bonds can be protected from water infiltration that can weaken the bonding in the interfaces. Thus, the underwater bonding remains stable for at least 15 days (FIG. 9B).

The instant adhesion can be reversible (FIG. 9D). Although it shows ˜8% reduction in the adhesion strength after 10 times, it can be recovered after the adhesive surface is cleaned with alcohol to remove accumulated dust. But excessive alcohol makes the adhesive swell and consequently reduces the adhesion strength due to the weakened H-bonds, which makes the adhesive easy to peel off the substrates. The adhesion strength of DA-3.2 adhered to PE is reduced by ˜ 87% after soaked in alcohol for 3 seconds. A significant reduction of 96% and 97% in the adhesion strength on the wood and seashell surfaces is observed. This could be because the high roughness surfaces allow the alcohol to better penetrate the interfaces, thus causing debonding. The exhibited adhesion properties make it easily adhesive to a plastic cup at room temperature in a few seconds for repairing water leak. Additionally, after it is adhered to a weight with 0.97 kg underwater, the adhesive with only 5 mm in diameter can easily lift the weight.

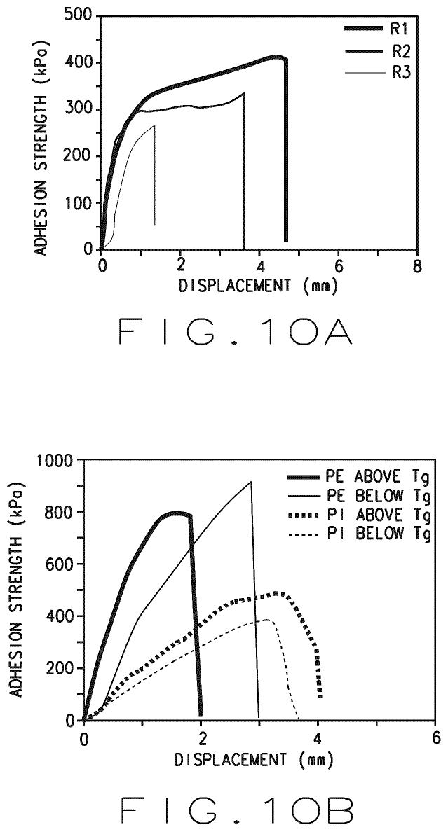

These results motivate exploration of the effect of surface roughness on the adhesion strength. To do that, three brass samples with different surface roughness (R1=1.32 μm, R2=0.42 μm, R3=0.11 μm) were prepared. FIG. 10A shows the shear stress test of the adhesives to these three types of brass samples with their statistic results summarized as follows: that the average adhesive strength to the brass surfaces with R1, R2, and R3 roughness is 409 kPa, 330 kPa, and 250 kPa, respectively. This suggests that increased surface roughness increases the adhesions strength. The strategy of combining the chemical and the structural adhesion can be applied as an active valve. An adhesive with a programmed cylindrical shape was inserted into an open tube in a funnel. Due to existence of a gap between the tube and the programmed shape of the adhesive, cold water flowed through the tube, while hot water was blocked by the SMP valve. Because as its shape recovered above T_{g} induced by the hot water, the valve expanded and adhered to the tube surface. The adhesive was adhered to the surface of a glass container with hot water above T_{g}. When the temperature was below T_{g}, the adhesion strength was improved so that the container was easily lifted.

To quantify the R2G adhesion, the adhesives were bonded to PE and PI above T_{g} and then the comparison shear stress testing was done above and below T_{g}. The results show that below T_{g} the adhesion strength of HA-2.2 adhered to PI and PE increases by 108% and 88% from 387 and 490 kPa tested above T_{g}, respectively (FIG. 10B), while below T_{g}, the adhesion strength of NVP-2.2 adhered to PI and PE increases by 249% and 190% from 228 and 314 kPa tested above T_{g}, respectively (FIG. 10B). When compared to the tape-type adhesives, the SMP (e.g., SME 50 and/or SME 60) adhesives demonstrated in this work achieved adhesion strength in a range of 238-924 kPa. Compared to adhesive hydrogels, which tend to have relatively low adhesion strength and can be easily damaged or ruptured under stress, the SMP adhesives show superior adhesion performance. It is worth mentioning that the adhesion of the SMPs can happen in <2 min. In summary, these properties are better than or comparable to the previously reported polymer or hydrogel adhesives.

Above T_{g}, SMP is soft and forms conformable contact with the surface texture with an applied pressure. Below T_{g}, the shape can be locked with much improved mechanical strength, which is combined with the enhanced interfacial area to afford greatly improved shear strength. To validate the mechanism, the finite element analysis (FEA) was performed to simulate how the shape transition can improve the adhesion using a single lap joint as a model. The numerical results show that the shear strength becomes larger as the roughness (simulated by the amplitude of sinuous functions) is increased, which is consistent with experimental results. The roughness imparts structure resistance to SMP to increase the shear stiffness and strength.

### Biocompatible Adhesive SME 60

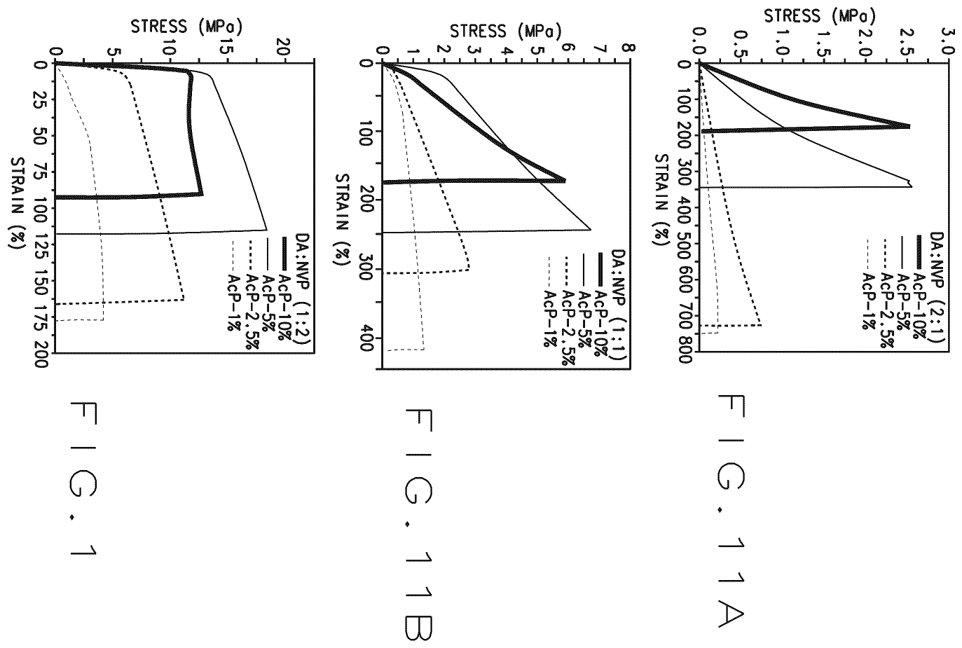

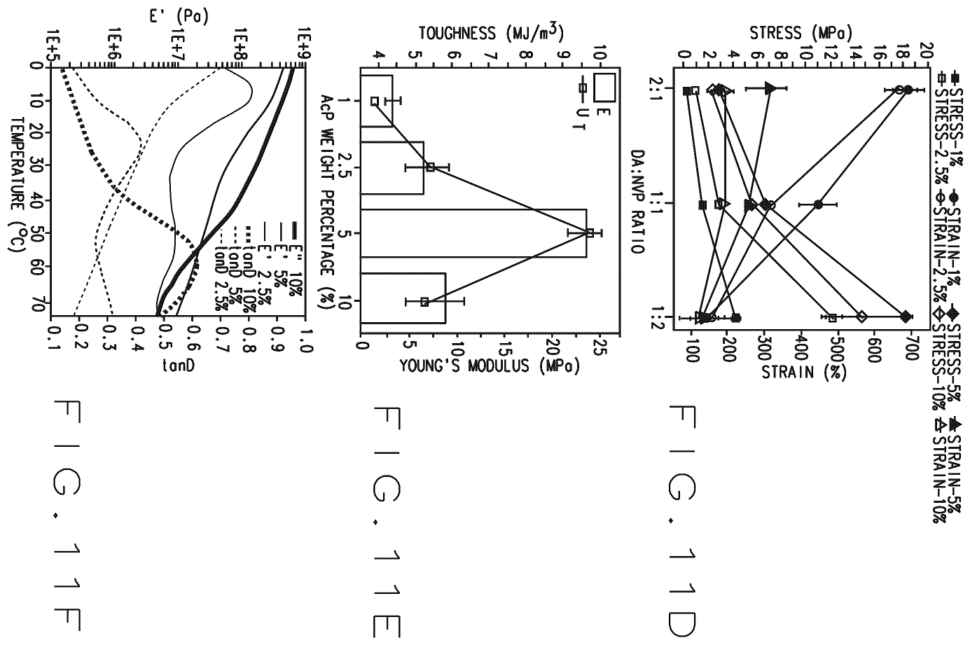

Mechanical properties of the 3D printed poly(AcP-DA-NVP) SMEs (e.g., SME 60) can be tuned by changing the weight ratios of DA, NVP, and AcP. The tensile stress-strain curves of the SME samples with varying DA:NVP weight ratios of 2:1, 1:1, and 1:2 and AcP weight ratios of 1 wt %, 2.5 wt %, 5 wt %, and 10 wt % are shown in FIG. 11A-11C. In the 2:1 DA:NVP samples, the mechanical strength increases with the AcP concentration, reaching a maximum at 5%. A similar trend is observed for the samples with 1:1 and 1:2 DA:NVP ratios, respectively. The tensile strength (σₜ) and fracture strain (ε_{f}) derived from FIGS. 11A-11C are summarized in FIG. 11D. FIG. 11D shows that increasing the NVP content from a DA:NVP ratio of 2:1 to 1:2 significantly increases σₜ while reducing ε_{f}. This is because DA acts as a soft segment, imparting rubber-like properties, while NVP contributes hard segments to the polymer chains for increasing its strength. For example, the samples with 2:1 DA:NVP ratio and AcP concentrations of 1%, 2.5%, 5%, and 10% show σₜ of 0.3 MPa, 0.9 MPa, 2.7 MPa, and 2.3 MPa, respectively, at ε_{f} of 698%, 677%, 309%, and 199%. Similarly, the samples with the 1:1 DA:NVP ratio, these numbers are 1.5 MPa, 2.8 MPa, 6.5 MPa, and 5.6 MPa, respectively, at corresponding εᵣ of 448%, 319%, 253%, and 191%. For the samples with 1:2 DA:NVP ratio, 1%-10% AcP changes σₜ to 4.5 MPa, 12 MPa, 18.5 MPa, and 14.5 MPa, respectively, at corresponding ε_{f} of 151%, 148%, 140%, and 114%.

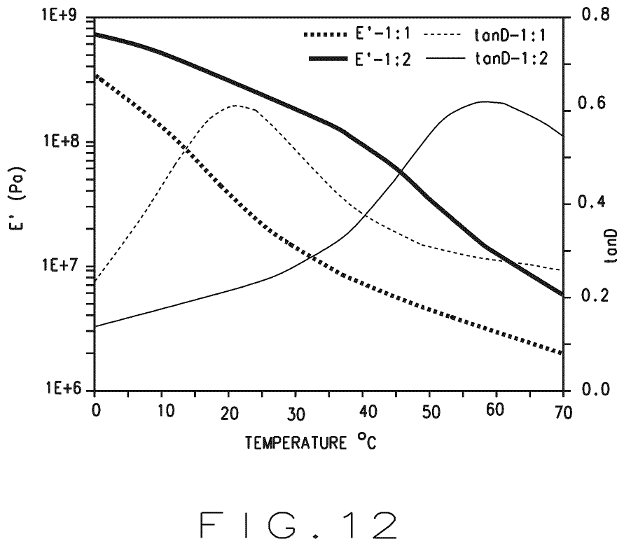

Toughness (U_{T}) and Young's modulus (E), derived from the stress-strain curves in FIG. 11B, are plotted in FIG. 11E. The U_{T} and E range from ˜4 MJ/m₃ and ˜4 MPa for the SME with 1% AcP to ˜ 10 MJ/m₃ and ˜24 MPa for the SME with 5% AcP, respectively. However, if increasing the AcP to 10%, U_{T} and E are reduced to ˜5 MJ/m₃ and ˜9 MPa, respectively. This could be because, as a crosslinker the increased AcP may hinder the polymer chain motion, leading to decreased fracture strain or stretchability. This hypothesis was validated by dynamic mechanical analysis (DMA) test (FIG. 11F). For the sample with a 1:2 DA:NVP ratio, increasing the AcP content from 2.5% to 10% raises the glass transition temperature (T_{g}) from ˜10° C. to ˜60° C., indicating increased stiffness and rigidity. T_{g} can be varied by tuning the DA:NVP ratios. For instance, at 10% AcP, changing the DA:NVP ratio from 1:2 to 1:1 lowers T_{g} from ˜60° C. to ˜20° C. (FIG. 12), thus tuning the shape memory behaviors.

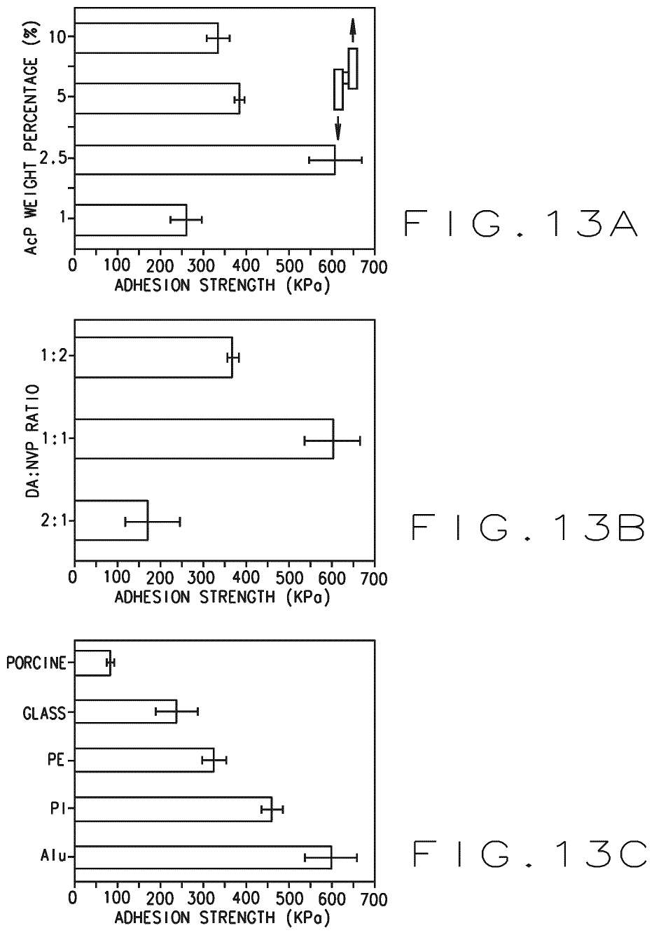

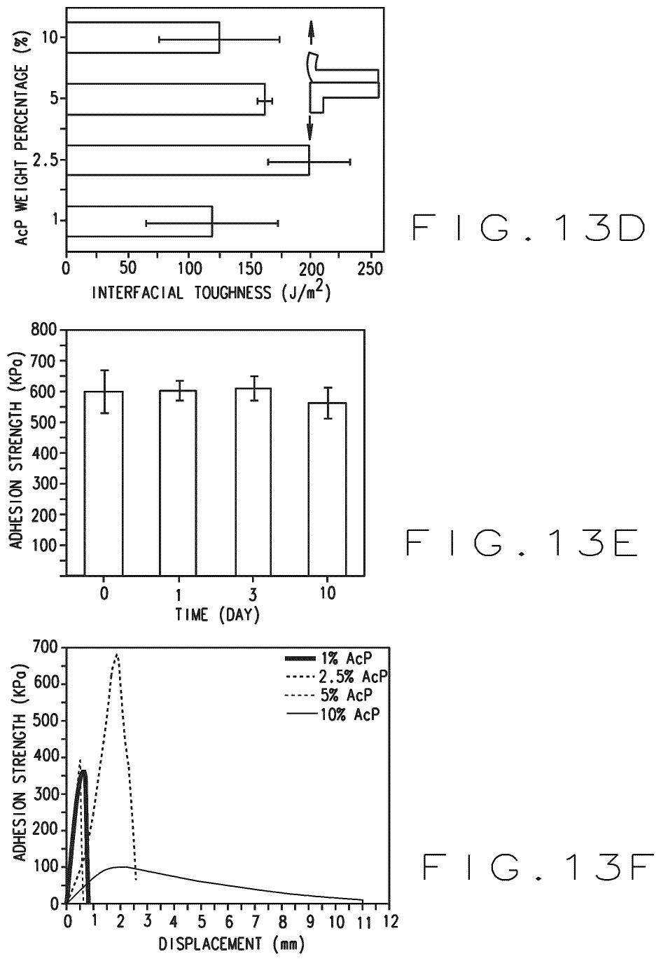

Besides the tunable mechanical and thermomechanical properties, the poly(AcP-DA-NVP) SMEs (e.g., SME 60) exhibit prominent adhesion strength to different types of tissues such as chicken heart, gizzard, lung, skin, and trachea. To quantify the adhesion strength, shear test on aluminum was performed (FIGS. 13A and 13F). It can be seen that the adhesion strength is largely influenced by the AcP weight ratio. For instance, the SMEs printed from inks with a 1:1 DA:NVP ratio and different AcP weight ratios from 1% to 10% exhibit adhesion strength ranging from 250 KPa to 600 KPa. The sample with 2.5% AcP reaches maximum one of ˜600 KPa. It suggests that to get optimum properties the monomer residue weight ratio plays an important role. Furthermore, we fixed AcP to 2.5% and tuned DA:NVP ratios to change adhesion strength (FIG. 13C). NVP, which plays a crucial role in adhesion due to its hydrogen bonding capabilities, first enhances the adhesion strength from ˜ 150 KPa to 600 KPa as the DA:NVP ratio decreases from 2:1 to 1:1. But if the DA:NVP ratio is further decreased to 1:2, the adhesion strength decreases to ˜ 350 kPa. This could be because NVP as a hard segment reduces the polymer chain mobility and flexibility which in turn decreases the interfacial contact and hinders hydrogen bond formation. Additional shear tests to different substances were conducted for the SME samples with 1:1 DA:NVP and 2.5% AcP. The corresponding adhesion strengths are ˜90, ˜250 KPa, ˜350 KPa, ˜450 KPa, and ˜600 KPa, respectively.

To calculate the interfacial toughness, peeling tests on the SME samples (e.g., SME 50 and/or SME 60) with 1:1 DA:NVP and different weight ratios of AcP and the aluminum were conducted. The value first increases from ˜125 J/m₂ for 1% AcP to ˜200 J/m₂ for 2.5% AcP and then decreases to ˜160 J/m₂ and ˜ 120 J/m₂ for 5% and 10% AcP, respectively. To evaluate the adhesion robustness underwater, we first tested the water uptake. The sample 1:1 of DA:NVP ratio with 2.5% AcP, shows a relatively low swelling ratio of 65% by weight even after being immersed in PBS for 30 days, it also showed that changing the DA:NVP ratio can change the swelling percentage decreasing from ˜120% to ˜15% for 1:2 DA:NVP ratio and 2:1 DA:NVP ratio, respectively, but it shows the swelling is still relatively low. Also, the volume change of swelling ratio of these samples were measured. It is observed that the volume increases by ˜50%, ˜100%, and ˜240%, respectively, for samples with DA:NVP ratio of 2:1, 1:1, 1:2, respectively. This hydrophobicity effectively shields the hydrophilic hydrogen bonds from infiltration, preventing the weakening of interfacial bonding. Consequently, the underwater adhesion demonstrates excellent robustness, maintaining the value after 10 days of water immersion. The adhesive properties allow it to adhere to a plastic cup at room temperature within seconds, effectively sealing a water leak. Additionally, after it is adhered to a 500-gram weight underwater, the adhesive with size of 1 cm×1 cm can easily lift the weight. These results demonstrate the remarkable adhesion strength, stability, and versatility of the 3D-printed SMP adhesive structures that conform to various surfaces and environmental conditions, highlighting its potential as a skin and tissue adhesive in biomedical applications. Furthermore, biocompatibility assessments validate its safety and efficacy, ensuring its suitability for clinical applications.

### Example 9: Underwater Adhesion for On-Skin Sensor Application

An application of an underwater adhesive is to be used for on-skin electronics. Before testing such durability, a biocompatibility test of the adhesive should be conducted. Thanks to its bio-based content, the cells can proliferate when co-cultured with the SMP (e.g., SME 50) adhesive surface for 4 days. It should be noted that the average counts of the co-cultured cells are high with a cell viability of >80%. When the average value was 50% or higher, the percentage of cell viability was deemed optimal in other studies for evaluating the cytotoxicity of the materials. Therefore, this adhesive is not cytotoxic to cells, which is consistent with the results shown in other studies about the cytotoxicity of similar materials for on-skin applications. To test the signal acquisition performance, a conductive electrode capsulated with the developed SMP adhesive was used for electromyography (EMG) recording and compared to a commercial electrode without SMP protection. After 1 min underwater test, the commercial electrode without SMP swelled a lot due to water absorption and was easily detached from the skin, while the one encapsulated with the SMP adhesive remained the same surface shape and was firmly adhered to the skin. As a result, the EMG signals collected from the SMP electrode can be transmitted by a simple flexion motion, and the light bulb became brighter. Due to the strong and conformable adhesion to the skin, the conductive electrode capsuled with the SMP adhesive can record the EMG signals with such a high fidelity that from the collected EMG spectra various types of muscle motions can be distinguished. EGM signals were collected from the two different muscle motions. One is from flexion, a muscle motion that produces a high, sharp signal shape. The other is from twist, a small, slow muscle motion that produces a small, broad signal shape. Because of these high-fidelity EMG signals recorded underwater, a Morse coding system was conceived, a way to transmit various kinds of information through defined flexion and twist motions. They are defined as “dots” and “dashes”, respectively. With these Morse codes, various Latin alphabet can be transmitted through arm motions for a purpose of transmitting underwater immergence information. For instance, letter “S” can be represented by three continuous flexion motions and letter “O” can be interpreted by three continuous twist arm motions. Accordingly, the message “SOS” and “HELP” can be effectively transmitted via the EMG signals by swinging arms underwater.

### Example 10: Biocompatibility Testing of SME 60

The biocompatibility of poly(AcP-DA:NVP) SMEs (e.g., SME 60) was evaluated through in vitro culturing with C3H10T1/2 cells. Microscope images captured daily over a 4-day period show significant cell proliferation across all samples printed from inks with 1:1 DA:NVP and different AcP weight ratios of 1%, 5%, and 10%. Fluorescence images of C3H10T1/2 cells co-cultured with printed adhesive film for 1, 2, 3, and 4 days reveal living and dead cells stained blue and red, respectively. Statistical analysis was conducted for each day using a two-way ANOVA multiple comparisons test (p-value for all materials >0.05 vs. Control). It shows that there was no significant difference in cell survival between the control and material-co-cultured groups. The cell survival after 4 days was >95%, much higher than that of observed in SME 50, demonstrating excellent cytocompatibility of the SMEs across all AcP weight percentages. Additionally, SMEs are degradable. For example, the samples with 2:1 and 1:1 DA:NVP ratios show a weight loss of 3% and 21%, respectively after 30 days in PBS incubated in 37° C., while 1:2 ratio showed 44% over the same period. It is expected that if put in a biological environment, the degradation rate would be speeded up.

To assess the biocompatibility of the SMEs, we conducted a co-culture assay with C3H10T1/2 cells in DMEM, which was supplemented with 10% FBS, 2 mM L-glutamine, 100 μg/mL penicillin, and 100 μg/mL streptomycin, under maintained 37° C. in a humidified atmosphere containing 5% CO₂. The materials were sterilized by soaking in ethanol for 1 hour, thoroughly dried, and pre-incubated in DMEM for 48 hours prior to being introduced into the co-culture system. The cells were stained with 20 μg/mL propidium iodide (PI) solution at 4° C. for 15 minutes in the dark. After staining, the samples were fixed in 10% formalin for 10 minutes at room temperature, rinsed with PBS, and mounted on slides using DAPI-containing medium. Cell viability was monitored on days 1, 2, 3, and 4, with brightfield images captured using a Nikon microscope after the same durations. Fluorescent images were acquired with a Keyence microscope and analyzed using ImageJ software, with cell survival percentages calculated by dividing the number of PI-positive cells by the total cell count.

### Example 11: Statistical Analysis

All experiments were conducted in triplicate to ensure reproducibility. The data were analyzed using a two-way ANOVA test, and the results are presented as mean±standard deviation. A p-value of <0.05 was considered statistically significant. Statistical analyses were performed using GraphPad Prism 9 software.

In view of the above, it will be seen that the several objects and advantages of the present invention have been achieved and other advantageous results have been obtained. The polymer and copolymers described herein, as well as their methods of production and control and the applications for them, constitute a significant advance in the ability to synthesize and use metal-free, high-capacity polymer materials.

As various changes could be made in the above constructions without departing from the scope of the invention, it is intended that all matter contained in the above description or shown in the accompanying drawings shall be interpreted as illustrative and not in a limiting sense.

What is claimed is:

1. An adhesive shape memory elastomer (SME) that can adhere to a substrate surface, said SME comprising an original shape that is set during a synthesis of the adhesive SME, the adhesive SME comprising:
a copolymer network, the copolymer network comprising:
a first monomer residue, the first monomer residue being a hydrophilic biocompatible monomer residue with at least one hydrogen bond acceptor;
a second monomer residue, the second monomer residue being a monomer residue with a hydrophobic alkyl side chain; and;
a third monomer residue, the third monomer residue comprising at least one hydrogen bond donor;
wherein the first monomer residue, the second monomer residue, and the third monomer residue are covalently bonded to one another,
wherein the adhesive SME can adhere to the substrate surface via noncovalent interactions between the copolymer network and the substrate surface.

2. The adhesive SME of claim 1 wherein the adhesive SME undergoes a transition from a glassy state to a rubbery state as it is heated past a glass transition temperature T_{g}, wherein the adhesive SME in the rubbery state can be deformed from the original shape into a programmed shape, such that the adhesive SME in the rubbery state can be applied to the substrate surface, whereby the programmed shape of the adhesive SME conforms to the substrate surface, and the adhesive SME can subsequently be cooled to the glassy state to physically adhere to the substrate surface.

3. The adhesive SME of claim 1 wherein the first monomer residue is a residue of N-vinylpyrrolidone (NVP), the second monomer residue is a residue of dodecyl acrylate (DA), and the third monomer residue is a residue of 2-hydroxy-3-phenoxypropyl acrylate (HA), further wherein the copolymer network is a NVP-DA-HA copolymer network.

4. The adhesive SME of claim 2 wherein the SME undergoes a physical transition at a glass transition temperature T_{g} between 10° C. and 60° C.

5. The adhesive SME of claim 3 wherein the NVP-DA-HA copolymer network comprises NVP, DA, and HA in a NVP:DA:HA weight ratio of 1:3.2:1.

6. The adhesive SME of claim 1 wherein the adhesive SME exhibits an adhesion strength of greater than 200 kPa when adhered to the substrate surface.

7. A biocompatible adhesive shape memory elastomer (SME) that can adhere to a substrate surface, said SME comprising an original shape that is set during a synthesis of the biocompatible adhesive SME, the biocompatible adhesive SME comprising:
a copolymer network, the copolymer network comprising:
a first monomer residue, the first monomer residue being a hydrophilic biocompatible monomer residue with at least one first hydrogen bond acceptor;
a second monomer residue, the second monomer residue being a monomer residue with a hydrophobic alkyl side chain; and;
an oligomer residue, the oligomer residue comprising at least one second hydrogen bond acceptor and an alkyl chain;
wherein the first monomer residue, the second monomer residue, and the oligomer residue are covalently bonded to one another,
wherein the adhesive SME can adhere to the substrate surface via noncovalent interactions between the copolymer network and the substrate surface.

8. The biocompatible SME of claim 7 wherein the biocompatible adhesive SME undergoes a transition from a glassy state to a rubbery state as it is heated past a glass transition temperature T_{g}, wherein the biocompatible adhesive SME in the rubbery state can be applied to the substrate surface, whereby the biocompatible adhesive SME is deformed to a programmed shape that conforms to the substrate surface, and the biocompatible adhesive SME can subsequently be cooled to the glassy state to adhere to the substrate surface.

9. The biocompatible adhesive SME of claim 7 wherein the first monomer residue is a residue of N-vinylpyrrolidone (NVP), the second monomer residue is a residue of dodecyl acrylate (DA), and the oligomer residue is a residue of poly(ethylene glycol-co-dodecanedioic acid) diacrylate (AcP), further wherein the copolymer network is a NVP-DA-AcP copolymer network.

10. The biocompatible adhesive SME of claim 9 wherein the NVP-DA-AcP copolymer network comprises NVP, DA, and AcP in a NVP:DA weight ratio of 1:1 and an AcP percentage of 2.5% by weight.

11. The biocompatible adhesive SME of claim 8 wherein the SME undergoes a physical transition at a glass transition temperature T_{g} in the range of 10° C.-60° C.

12. The biocompatible adhesive SME of claim 11 wherein the SME undergoes a physical transition at a glass transition temperature T_{g} in the range of 38° C.-42° C.

13. The biocompatible adhesive SME of claim 7 wherein the adhesive biocompatible SME exhibits an adhesion strength of greater than 250 kPa when adhered to aluminum.

14. A shape memory elastomer (SME), said SME comprising:
a copolymer network, the copolymer network comprising:
a first monomer residue, the first monomer residue being a hydrophilic biocompatible monomer residue with at least one hydrogen bond acceptor;
a second monomer residue, the second monomer residue being a monomer residue with a hydrophobic alkyl side chain; and;
a crosslinker, the crosslinker being one of either a third monomer residue or an oligomer residue, the third monomer residue comprising at least one hydrogen bond donor, the oligomer residue comprising at least one second hydrogen bond acceptor and an alkyl chain;
wherein the first monomer residue, the second monomer residue, and the crosslinker are covalently bonded to one another.

15. The SME of claim 14 wherein the first monomer residue is a residue of N-vinylpyrrolidone (NVP), the second monomer residue is a residue of dodecyl acrylate (DA), the third monomer residue is a residue of 2-hydroxy-3-phenoxypropyl acrylate (HA) and the oligomer residue is a residue of poly(ethylene glycol-co-dodecanedioic acid) diacrylate (AcP).

16. The SME of claim 14 wherein the SME undergoes a physical transition at a glass transition temperature T_{g} in the range of 10° C.-60° C.

17. The SME of claim 16 wherein the SME undergoes a physical transition at a glass transition temperature T_{g} in the range of 38° C.-42° C.
